(19) United States
(12) Patent Application Publication
(10) Pub. No.: US 2010/0250936 A1
(43) Pub. Date: Sep. 30, 2010

(54) INTEGRATED CIRCUIT, ENCRYPTION COMMUNICATION APPARATUS, ENCRYPTION COMMUNICATION SYSTEM, INFORMATION PROCESSING METHOD AND ENCRYPTION COMMUNICATION METHOD

(76) Inventors: Masafumi Kusakawa, Tokyo (JP); Yoshikazu Miyato, Saitama (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/725,134

(22) Filed: Mar. 16, 2010

(30) Foreign Application Priority Data
Mar. 25, 2009 (JP) P2009-073676

(51) Int. Cl. H04L 9/32; G06F 12/14

(52) U.S. Cl. 713/169; 713/189; 713/171

(57) ABSTRACT

There is provided an integrated circuit includes an arithmetic circuit having input/output characteristics determined by element-specific physical characteristics; a storage unit having cipher text obtained by performing encryption processing on predetermined secret information using an output value output from the arithmetic circuit with respect to input of a predetermined value and the predetermined value input into the arithmetic circuit stored therein; and a decryption unit that restores the predetermined secret information by inputting the predetermined value stored in the storage unit into the arithmetic circuit and decrypting the cipher text stored in the storage unit using the output value output from the arithmetic circuit when the predetermined secret information is used.

### BACKGROUND OF THE INVENTION

1. Field of the Invention

The present invention relates to an integrated circuit, an encryption communication apparatus, an encryption communication system, an information processing method, and an encryption communication method.

2. Description of the Related Art

Various kinds of cards such as credit cards, cash cards, prepaid cards, identification cards, and various membership cards are used in a variety of situations. Such various cards have information about the type of card, issuer, holder and the like stored therein. In a magnetic card, for example, such information is recorded in a magnetic stripe on the card. Thus, there is danger that magnetic information is illegally read or falsified by a technique called skimming. On the other hand, with widespread use of cards, various kinds of services using cards are increasingly offered, increasing information recorded in cards in quantity and value. Thus, realization of cards capable of safely protecting a large amount of data is demanded.

In response to such demands, cards called IC cards in which small semiconductor integrated circuits (hereinafter, called IC) are mounted inside the cards are increasingly used in recent years. In an IC card, various kinds of information are stored in a nonvolatile memory provided in the IC. Thus, more information can be stored than in a magnetic card. Moreover, an encryption circuit is mounted in the IC and when communication is performed with a reader/writer terminal (hereinafter, a terminal) that reads/writes information in the IC card, mutual authentication and encryption communication are performed. Thus, even if communication is intercepted, it is very difficult to acquire content thereof as long as a key used for mutual authentication or encryption communication is unknown.

A key used for mutual authentication is, for example, embedded as a portion of a wiring structure of IC or held as a portion of program data stored in a nonvolatile memory. Thus, it is necessary to reverse-engineer the IC or duplicate the IC and program data stored in the nonvolatile memory thereof to acquire the key from the IC. However, it becomes necessary to have professional expertise and advanced analysis facilities to perform an illegal analysis act such as reverse-engineering and a duplication act. Thus, creating an illegal terminal or an illegal IC card using information obtained by an illegal analysis act is considered to be difficult.

For the above reasons, nowadays IC cards are widely used for uses of holding a large amount of information of high value of money information and the like such as cards for satellite pay broadcasting and cards handling electronic money. Moreover, various services using IC cards in which information of high value is recorded are increasingly offered. On the other hand, various attack techniques such as an advanced illegal analysis technology on ICs and an illegal acquisition technology of key using a test circuit are proposed. Further, a technology to create duplicate ICs by exposing the structure of a whole IC is lately studied. If an IC is duplicated, the circuit structure of the IC and content of the nonvolatile memory are also duplicated so that keys used for mutual authentication and encryption communication are also duplicated. As a result, mutual authentication and encryption communication are substantially invalidated.

As a countermeasure against such uses of illegally duplicated ICs, a method described in “G. E. Suh and S. Devadas, “Physical Unclonable Functions for Device Authentication and Secret Key Generation”, The 44th Design Automation Conference, pp. 9-14, 2007” can be used. The method described therein relates to a technology that distinguishes between an illegally duplicated IC and an original IC by using a physical unclonable function (PUF) to enable mutual authentication and encryption communication only with the original IC. The PUF is a kind of arithmetic circuit configured to output a different value for each IC for the same input value by using fluctuations in each IC generated in actual manufacture, though the IC design is the same. Therefore, even if the input value is the same, the output value output by the PUF mounted in the original IC and that output by the PUF mounted in an illegally duplicated IC are different. The technology described therein utilizes such a property of PUF.

### SUMMARY OF THE INVENTION

The technology described above will briefly be described. According to the technology, a large number of pairs of input values (hereinafter, challenge values) and output values (hereinafter, response values) generated by using a PUF for each IC are held and some challenge value is input into the PUF for authentication to compare output thereof and the held response value. Naturally, if the IC into which the challenge value is input is an original IC, the output thereof and the response value match and, if the IC is an illegally duplicated IC, the output thereof and the response value do not match. Normally, pairs of challenge values and response values are generated for each IC before product shipment and held by the manufacturer or the like (hereinafter, the center). Then, an authenticator references pair information held by the center to provide the challenge value for each IC for authentication and also to perform the comparison processing by using the response value obtained from the IC.

However, if a technology such as the above technology that holds a large number of pairs of challenge values and response values (hereinafter, challenges/responses) is used, a database capable of storing data of a very large size will be necessary. If, for example, a plurality of pairs is used for one IC to maintain security, as many challenges/responses as the number of ICs in circulation×the number of pairs used by each IC will be necessary. Constructing such a database in the center may not be impracticable. However, there is an issue that only terminals capable of accessing the database in the center can perform authentication processing for ICs. Further, when mutual authentication should be performed between an IC and a terminal, there is an issue that it is practically very difficult to realize mutual authentication by using the above technology because it is realistically very difficult to store such a database in the IC.

Thus, the present invention has been made in view of the above issues and it is desirable to provide a novel and improved integrated circuit capable of realizing secure authentication using a PUF without using a database in which challenges/responses for each IC are stored, an encryption communication apparatus, an encryption communication system, an information processing method, and an encryption communication method.

According to an embodiment of the present invention, there is provided an integrated circuit which includes an arithmetic circuit having input/output characteristics determined by element-specific physical characteristics; a storage unit having cipher text obtained by performing encryption processing on predetermined secret information using an output value output from the arithmetic circuit with respect to input of a predetermined value and the predetermined value input into the arithmetic circuit stored therein; and a decryption unit that restores the predetermined secret information by inputting the predetermined value stored in the storage unit into the arithmetic circuit and decrypting the cipher text stored in the storage unit using the output value output from the arithmetic circuit when the predetermined secret information is used.

Furthermore, the integrated circuit may further include an output value acquisition unit that inputs the predetermined value into the arithmetic circuit to acquire the output value and also stores the predetermined value in the storage unit when the predetermined value is given from outside; and an encryption unit that encrypts the predetermined secret information using the output value acquired by the output value acquisition unit by using the arithmetic circuit as a key and stores the cipher text obtained by the encryption processing to the storage unit when the predetermined secret information is given together with the predetermined value.

Furthermore, a key for mutual authentication is stored in the storage unit as the predetermined secret information in a form of the cipher text using the output value as the key and when mutual authentication is performed using the key for mutual authentication, the decryption unit restores the key for mutual authentication by inputting the predetermined value stored in the storage unit into the arithmetic circuit and decrypting the cipher text stored in the storage unit using the output value output from the arithmetic circuit.

According to an embodiment of the present invention, there is provided an encryption communication apparatus which includes an integrated circuit including an arithmetic circuit having input/output characteristics determined by element-specific physical characteristics, a storage unit having cipher text obtained by performing encryption processing on predetermined secret information shared with an external apparatus using an output value output from the arithmetic circuit with respect to input of a predetermined value and the predetermined value input into the arithmetic circuit stored therein, and a decryption unit that restores the predetermined secret information by inputting the predetermined value stored in the storage unit into the arithmetic circuit and decrypting the cipher text stored in the storage unit using the output value output from the arithmetic circuit when the predetermined secret information is used; a mutual authentication unit that acquires shared information by performing mutual authentication with the external apparatus; an encryption communication key generation unit that generates a key for encryption communication by combining the shared information acquired through the mutual authentication by the mutual authentication unit and the predetermined secret information restored by the decryption unit; and an encryption communication unit that performs encryption communication with the external apparatus using the key for encryption communication generated by the encryption communication key generation unit.

According to an embodiment of the present invention, there is provided an encryption communication system which includes a first communication apparatus and a second communication apparatus.

The first communication apparatus includes an integrated circuit including an arithmetic circuit having input/output characteristics determined by element-specific physical characteristics, a storage unit having cipher text obtained by performing encryption processing on predetermined secret information using an output value output from the arithmetic circuit as a key with respect to input of a predetermined value and the predetermined value input into the arithmetic circuit stored therein, and a decryption unit that restores the predetermined secret information by inputting the predetermined value stored in the storage unit into the arithmetic circuit and decrypting the cipher text stored in the storage unit using the output value output from the arithmetic circuit when the predetermined secret information is used; a mutual authentication unit that acquires shared information by performing mutual authentication with a second communication apparatus; an encryption communication key generation unit that restores the predetermined secret information by using the decryption unit to generate a key for encryption communication by combining the predetermined secret information and the shared information if the shared information is acquired after the successful mutual authentication with the second communication apparatus; and an encryption communication unit that performs encryption communication with the second communication apparatus using the key for encryption communication generated by the encryption communication key generation unit.

The second communication apparatus includes an integrated circuit including an arithmetic circuit having input/output characteristics determined by element-specific physical characteristics, a storage unit having the cipher text obtained by performing encryption processing on the predetermined secret information using an output value output from the arithmetic circuit as a key with respect to input of a predetermined value and the predetermined value input into the arithmetic circuit stored therein, and a decryption unit that restores the predetermined secret information by inputting the predetermined value stored in the storage unit into the arithmetic circuit and decrypting the cipher text stored in the storage unit using the output value output from the arithmetic circuit when the predetermined secret information is used; a mutual authentication unit that acquires the shared information by performing the mutual authentication with the first communication apparatus; an encryption communication key generation unit that restores the predetermined secret information by using the decryption unit to generate a key for encryption communication by combining the predetermined secret information and the shared information if the shared information is acquired after the successful mutual authentication with the first communication apparatus; and an encryption communication unit that performs encryption communication with the first communication apparatus using the key for encryption communication generated by the encryption communication key generation unit.

Furthermore, the first communication apparatus may further include an arithmetic unit that performs predetermined arithmetic processing with the key for encryption communication generated by the encryption communication key generation unit as a parameter on held information held by the first and second communication apparatuses; and a transmission unit that transmits a first arithmetic result output from the arithmetic unit to the second communication apparatus.

And the second communication apparatus may further include an arithmetic unit that performs predetermined arithmetic processing with the key for encryption communication generated by the encryption communication key generation unit as a parameter on held information held by the first and second communication apparatuses; and a transmission unit that transmits a second arithmetic result output from the arithmetic unit to the first communication apparatus.

Moreover, the first communication apparatus may compare the second arithmetic result received from the second communication apparatus and the first arithmetic result, the second communication apparatus may compare the first arithmetic result received from the first communication apparatus and the second arithmetic result. In this case, the encryption communication units held by the first and second communication apparatus may perform the encryption communication if the first and second arithmetic results match.

According to another embodiment of the present invention, there is provided an information processing method, including the steps of acquiring an output value corresponding to a predetermined value after the predetermined value stored in the storage unit being input into the arithmetic circuit when the predetermined secret information is used by using an integrated circuit including an arithmetic circuit having input/output characteristics determined by element-specific physical characteristics and a storage unit having cipher text obtained by performing encryption processing on predetermined secret information using an output value output from the arithmetic circuit as a key with respect to input of a predetermined value and the predetermined value input into the arithmetic circuit stored therein; and restoring the predetermined secret information by decrypting the cipher text stored in the storage unit using the output value output from the arithmetic circuit in the output value acquisition step.

Furthermore, the information processing method may further include the steps of acquiring shared information by performing mutual authentication with an external apparatus; generating a key for encryption communication by combining the shared information acquired by the mutual authentication in the mutual authentication step and the predetermined secret information restored in the restoration step; and performing encryption communication with the external apparatus using the key for encryption communication generated in the key generation step.

According to another embodiment of the present invention, there is provided an encryption communication method, including the steps of acquiring shared information by performing mutual authentication with a second communication apparatus; acquiring an output value corresponding to a predetermined value after the predetermined value stored in the storage unit being input into the arithmetic circuit if the shared information is acquired after the successful mutual authentication with the second communication apparatus by using an integrated circuit including an arithmetic circuit having input/output characteristics determined by element-specific physical characteristics and a storage unit having cipher text obtained by performing encryption processing on predetermined secret information using an output value as a key output from the arithmetic circuit with respect to input of a predetermined value and the predetermined value input into the arithmetic circuit stored therein; restoring the predetermined secret information by decrypting the cipher text stored in the storage unit using the output value output from the arithmetic circuit in the output value acquisition step; generating a key for encryption communication by combining the predetermined secret information restored in the restoration step and the shared information; and performing encryption communication with the second communication apparatus using the key for encryption communication generated in the key generation step by a first communication apparatus and acquiring shared information by performing the mutual authentication with the first communication apparatus; acquiring an output value corresponding to a predetermined value after the predetermined value stored in the storage unit being input into the arithmetic circuit if the shared information is acquired after the successful mutual authentication with the second communication apparatus by using an integrated circuit including an arithmetic circuit having input/output characteristics determined by element-specific physical characteristics and a storage unit having the cipher text obtained by performing encryption processing on predetermined secret information using an output value as a key output from the arithmetic circuit with respect to input of a predetermined value and the predetermined value input into the arithmetic circuit stored therein; restoring the predetermined secret information by decrypting the cipher text stored in the storage unit using the output value output from the arithmetic circuit in the output value acquisition step; generating a key for encryption communication by combining the predetermined secret information restored in the restoration step and the shared information; and performing encryption communication with the first communication apparatus using the key for encryption communication generated in the key generation step by the second communication apparatus.

According to another embodiment of the present invention, there is provided a program to cause a computer to realize functions held by the abovementioned device. Further, a computer readable recording medium in which the program is recorded may be provided.

According to the present invention, as described above, secure authentication using a PUF without using a database in which challenges/responses for each IC are stored can be realized.

### BRIEF DESCRIPTION OF THE DRAWINGS

FIG. 1 is an explanatory view illustrating an operation of a PUF;

FIG. 2 shows an example of an authentication processing method using the PUF;

FIG. 3 shows an example of the authentication processing method using the PUF;

FIG. 4 shows an example of the authentication processing method using the PUF;

FIG. 5 shows an example of the authentication processing method using the PUF;

FIG. 6 shows an example of the authentication processing method using the PUF;

FIG. 7 shows an example of the authentication processing method using the PUF;

FIG. 8 shows an example of the authentication processing method using the PUF;

FIG. 9 shows a configuration example of an IC card according to a first embodiment of the present invention;

FIG. 10 shows a configuration example of an IC card user terminal according to the embodiment;

FIG. 11 shows a flow of processing concerning a portion (registration phase) of authentication processing according to the embodiment;

FIG. 12 shows the flow of processing concerning a portion (PUF processing operation in the registration phase) of the authentication processing according to the embodiment;

FIG. 13 shows the flow of processing concerning a portion (PUF processing operation in the registration phase) of the authentication processing according to the embodiment;

FIG. 14 shows the flow of processing concerning a portion (PUF processing operation in the registration phase) of the authentication processing according to the embodiment;

FIG. 15 shows the flow of processing concerning a portion (PUF processing operation in the registration phase) of the authentication processing according to the embodiment;

FIG. 16 shows a configuration example of an IC card according to a second embodiment of the present invention;

FIG. 17 shows a configuration example of an IC card user terminal according to the embodiment;

FIG. 18 shows the flow of processing concerning a portion (authentication phase) of the authentication processing according to the embodiment;

FIG. 19 shows the flow of processing concerning a portion (key matching confirmation phase) of the authentication processing according to the embodiment;

FIG. 20 shows the flow of processing concerning a portion (key matching confirmation phase) of the authentication processing according to the embodiment;

FIG. 21 shows the flow of processing concerning a portion (key matching confirmation phase) of the authentication processing according to the embodiment;

FIG. 22 shows a configuration example of an IC card according to a third embodiment of the present invention;

FIG. 23 shows a configuration example of an IC card user terminal according to the embodiment;

FIG. 24 shows the flow of processing concerning a portion (PUF processing operation in the registration phase) of the authentication processing according to the embodiment;

FIG. 25 shows the flow of processing concerning a portion (PUF processing operation in the registration phase) of the authentication processing according to the embodiment; and

FIG. 26 shows the flow of processing concerning a portion (PUF processing operation in the registration phase) of the authentication processing according to the embodiment.

### DETAILED DESCRIPTION OF THE EMBODIMENTS

Hereinafter, preferred embodiments of the present invention will be described in detail with reference to the appended drawings. Note that, in this specification and the appended drawings, structural elements that have substantially the same function and structure are denoted with the same reference numerals, and repeated explanation of these structural elements is omitted.

### Flow of Description

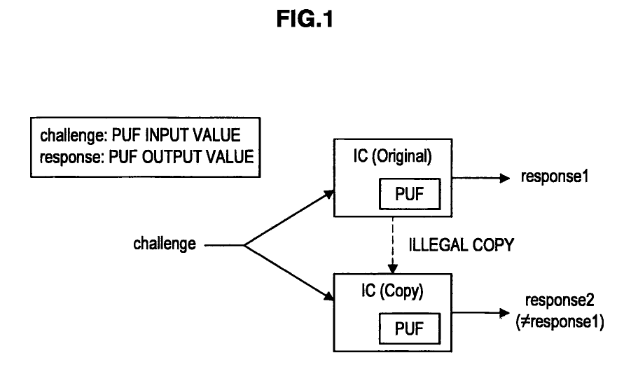

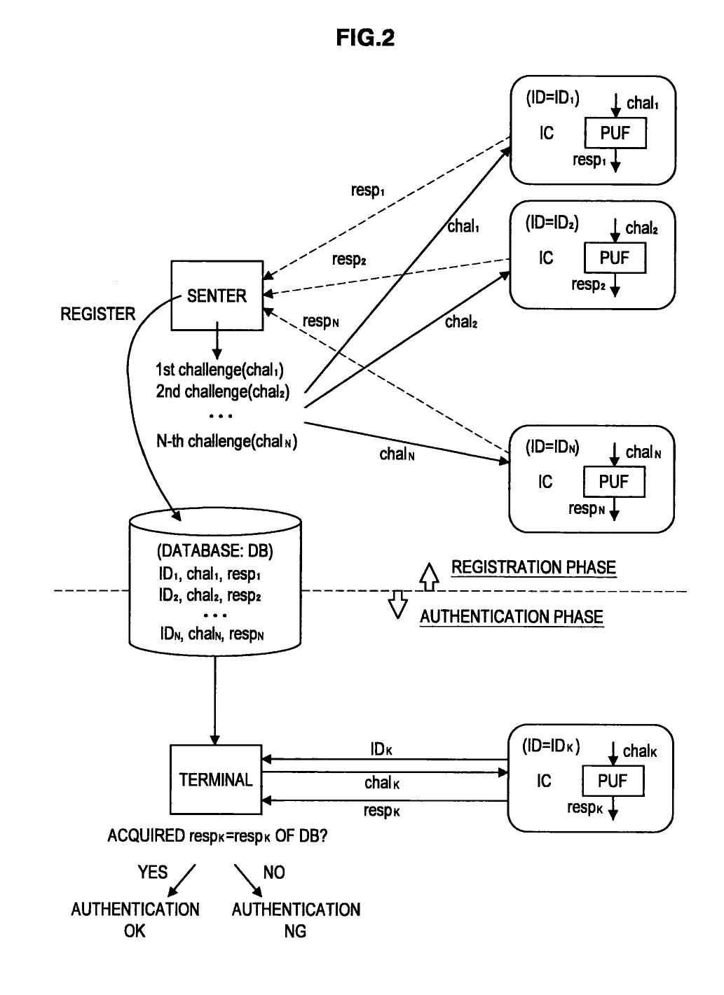

The flow of description concerning an embodiment of the present invention described below will briefly be described. First, an operation of PUF will briefly be described with reference to FIG. 1. Next, an authentication processing method using a database in which challenges/responses are stored with reference to FIGS. 2 to 8 will briefly be described. In the description thereof, issues to be resolved by technology according to each embodiment of the present invention will be described.

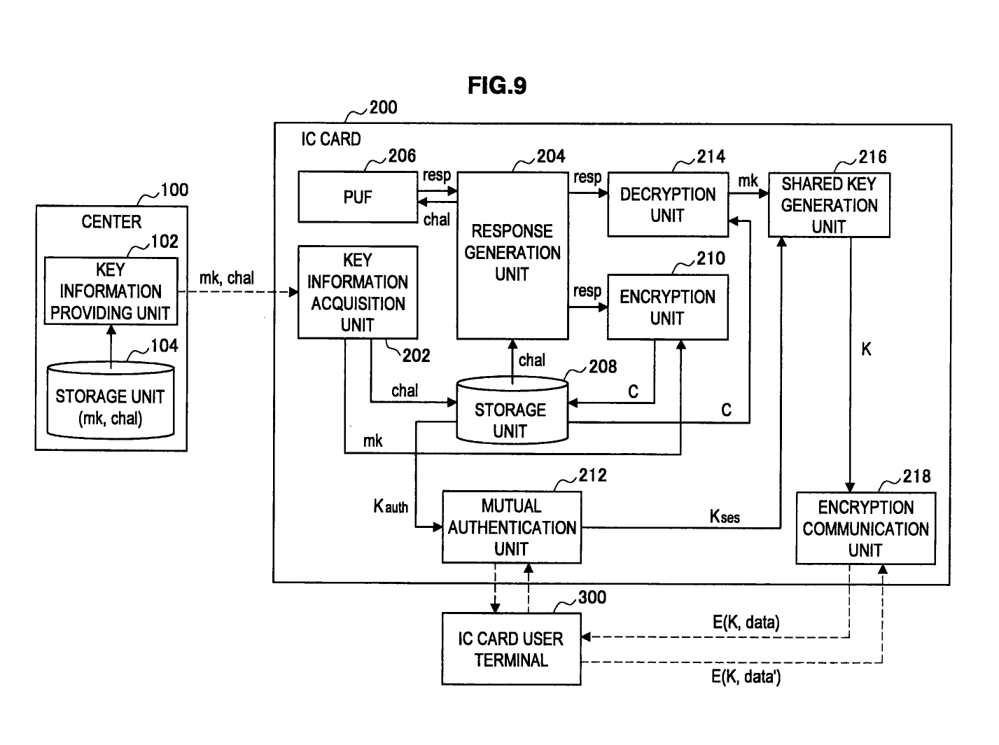

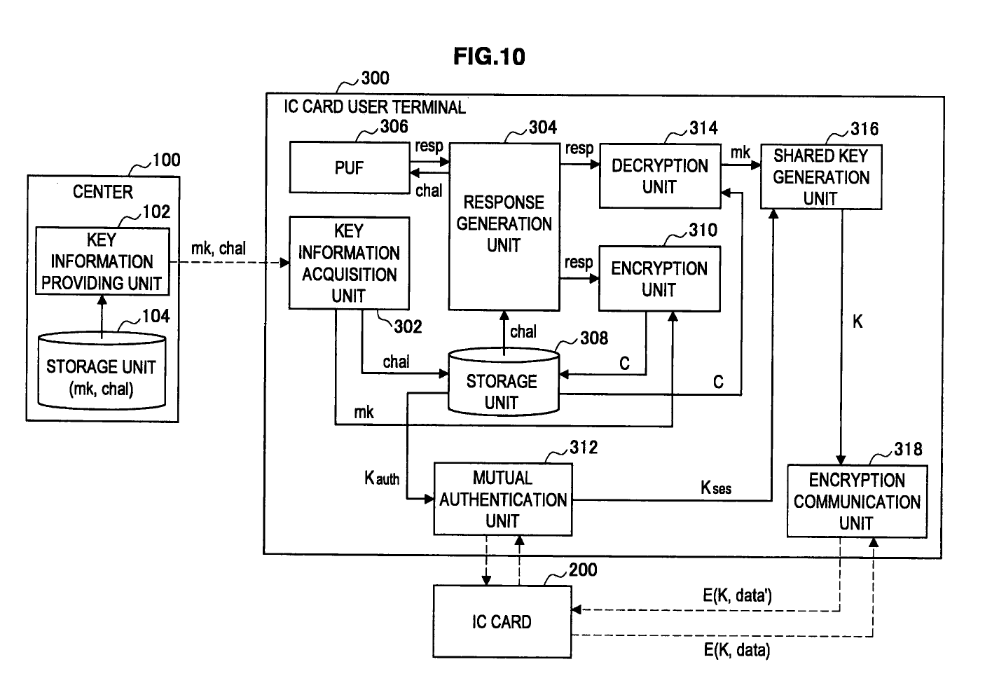

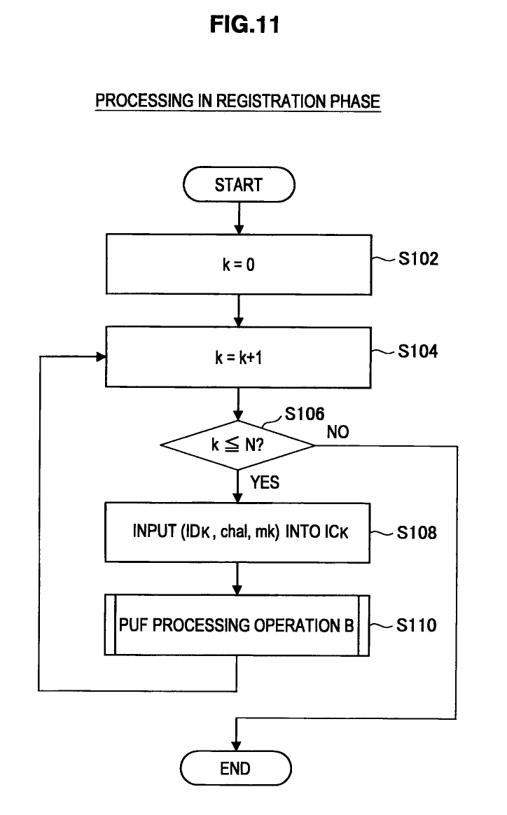

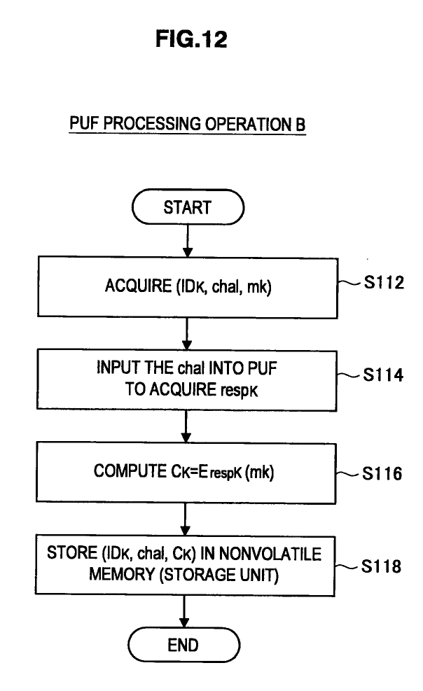

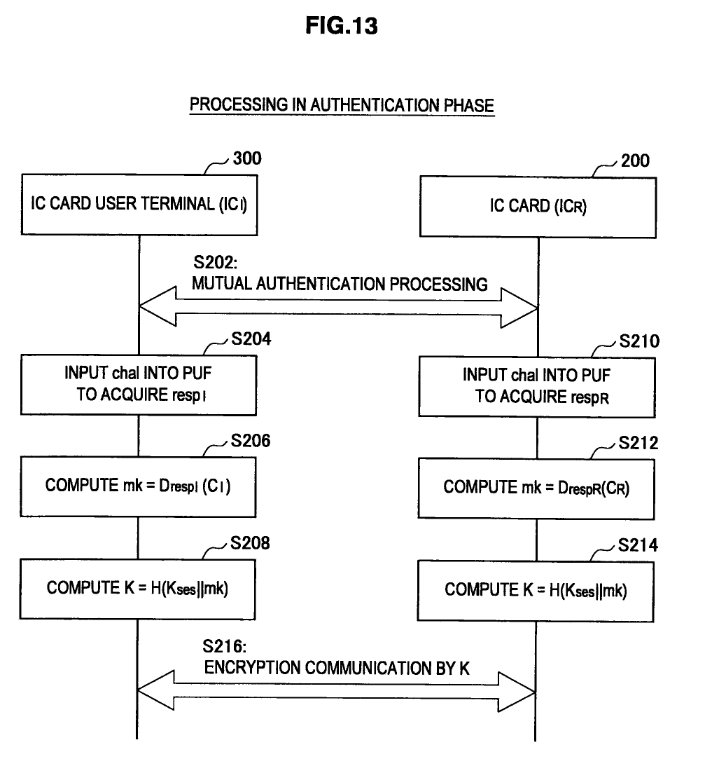

Next, functional configurations of an IC card 200 and an IC card user terminal 300 according to the first embodiment of the present invention will be described with reference to FIGS. 9 and 10 respectively. In the description thereof, a role of a center 100 in the embodiment will also be described. Further, the flow of processing performed in a registration phase described below will be described with reference to FIG. 11. Then, processing operations of the IC card 200 and the IC card user terminal 300 concerning portions using a PUF will be described with reference to FIG. 12. Next, the flow of processing performed in an authentication phase described below will be described with reference to FIGS. 13 to 15.

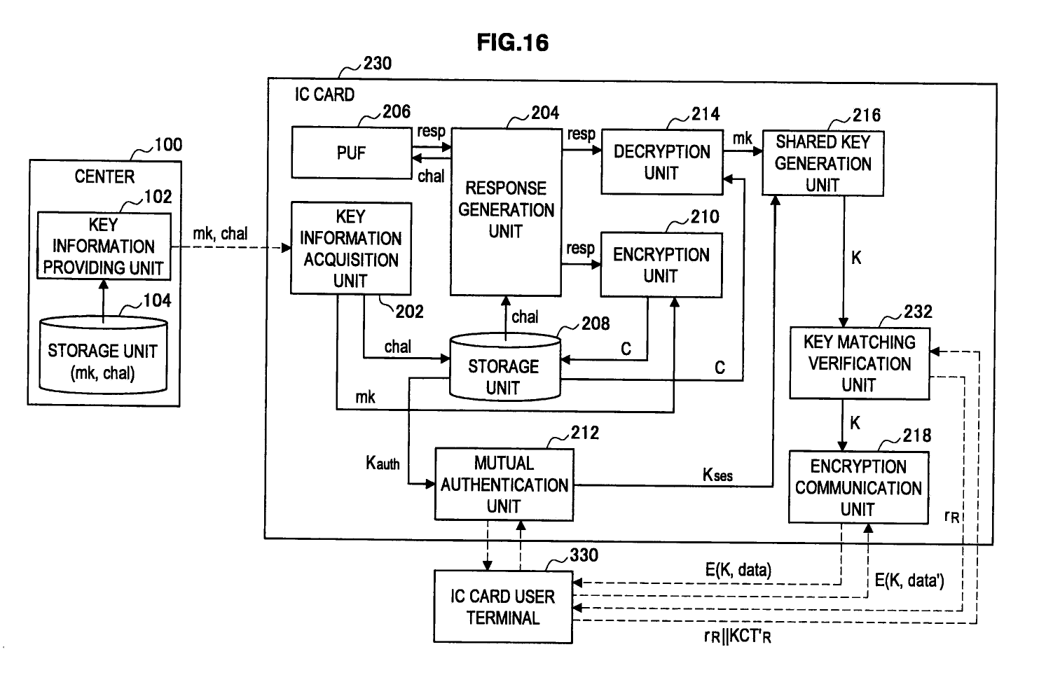

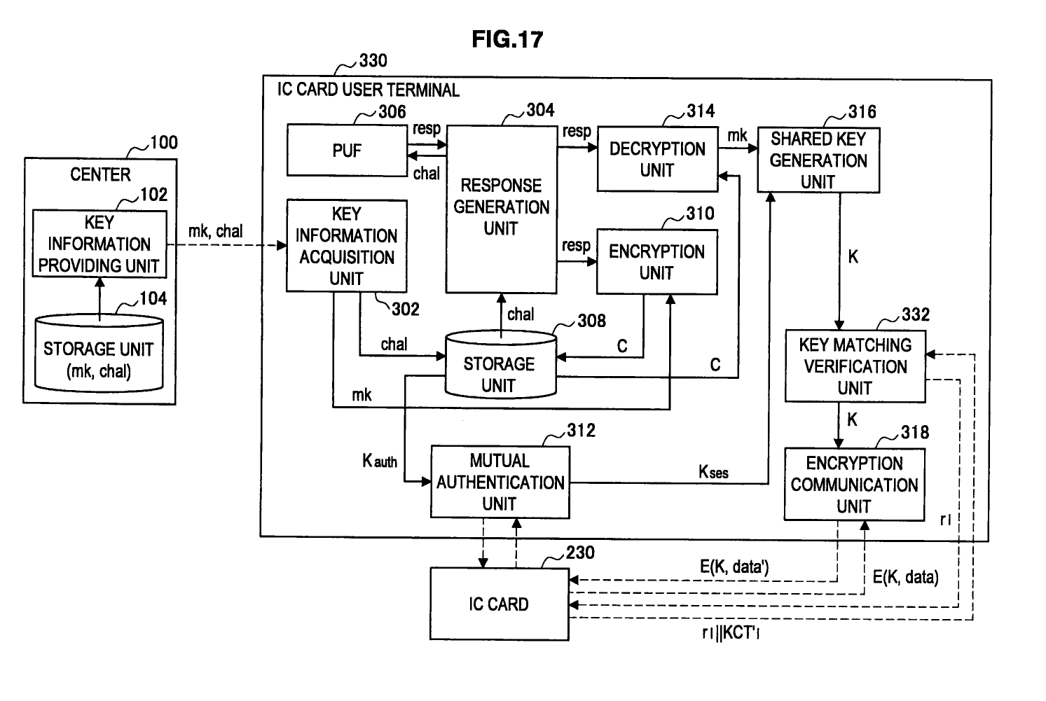

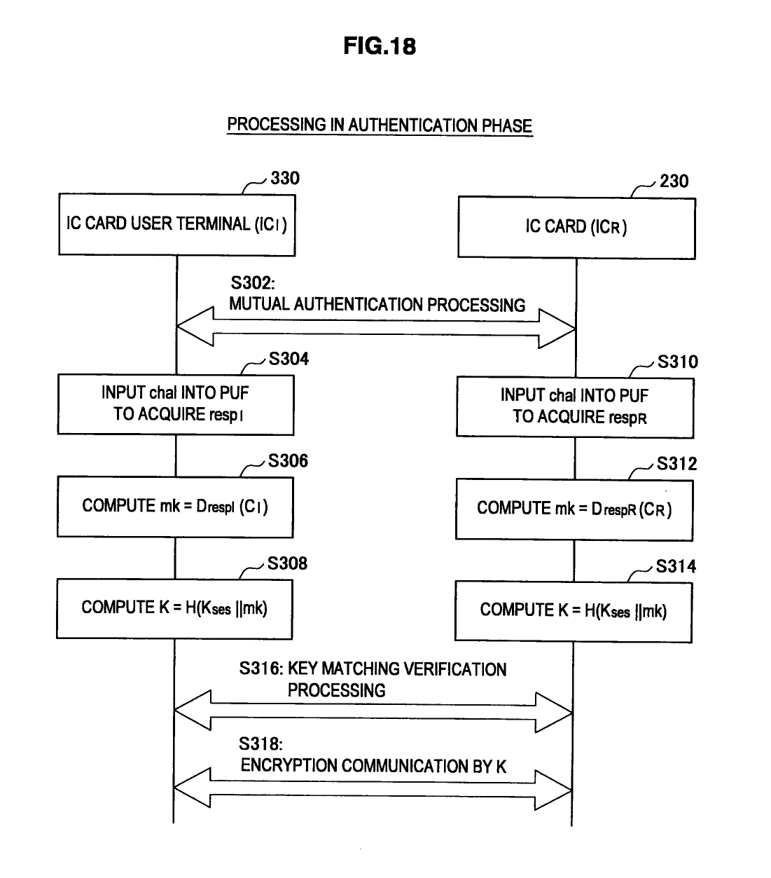

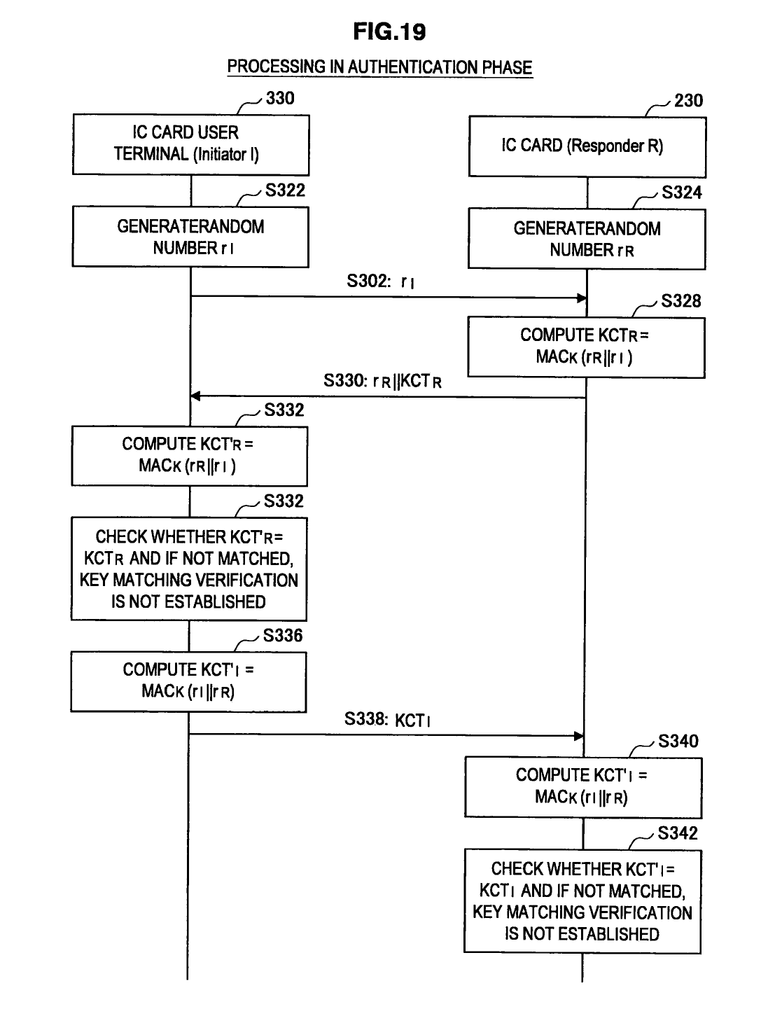

Next, functional configurations of an IC card 230 and an IC card user terminal 330 according to the second embodiment of the present invention will be described with reference to FIGS. 16 and 17 respectively. Next, the flow of processing performed by the IC card user terminal 330 and the IC card 230 in the authentication phase will be described with reference to FIG. 18. Next, the flow of processing performed by the IC card user terminal 330 and the IC card 230 in a key matching phase described below will be described with reference to FIGS. 19 to 21.

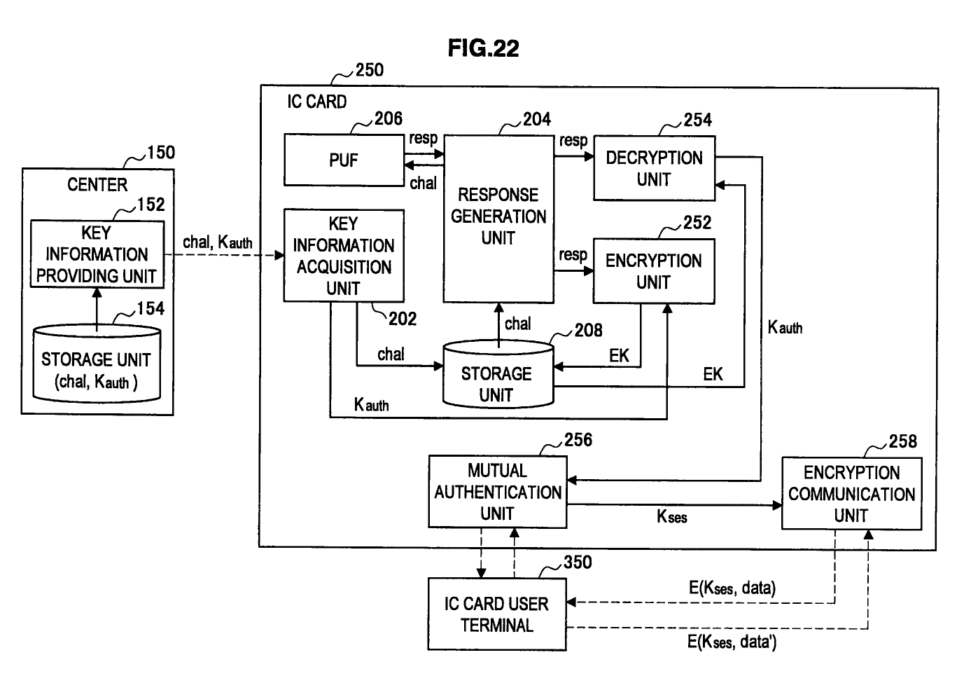

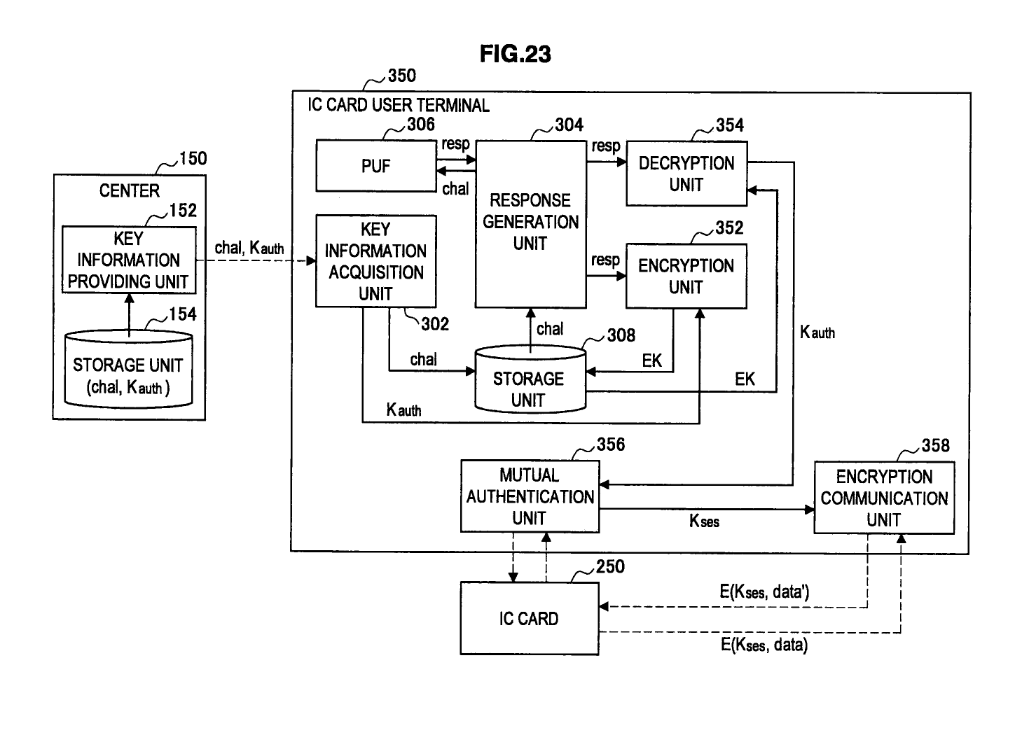

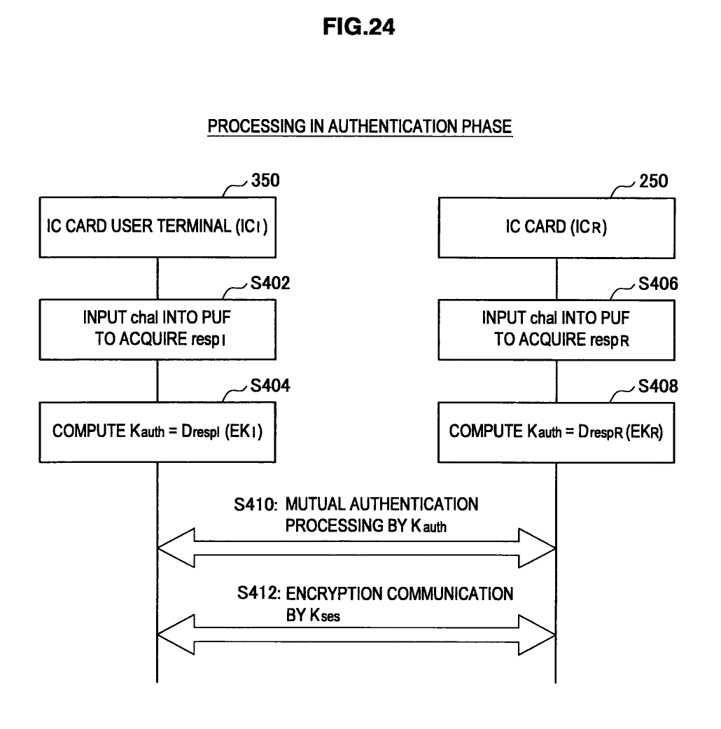

Next, functional configurations of an IC card 250 and an IC card user terminal 350 according to the third embodiment of the present invention will be described with reference to FIGS. 22 and 23 respectively. Next, the flow of processing performed by the IC card user terminal 350 and the IC card 250 in the authentication phase will be described with reference to FIGS. 24 to 26. Lastly, technical ideas of the embodiments will be summarized and operation effects obtained from the technical ideas will briefly be described.

(Description Items)

1: Authentication Processing Method Using PUF
1-1: Operation of PUF
1-2: Authentication Processing Method Using Database and PUF

2: First Embodiment
2-1: Functional Configuration of IC Card 200
2-2: Functional Configuration of IC Card User Terminal 300
2-3: Processing in Registration Phase
2-4: Processing in Authentication Phase

3: Second Embodiment
3-1: Functional Configuration of IC Card 230
3-2: Functional Configuration of IC Card User Terminal 330
3-3: Processing in Authentication Phase
   3-3-1: Overall flow of processing
   3-3-2: Key matching confirmation phase

4: Third Embodiment
4-1: Functional Configuration of IC Card 250
4-2: Functional Configuration of IC Card User Terminal 350
4-3: Processing in Authentication Phase

5: Summary

### 1: Authentication Processing Method Using PUF

First, before starting to describe the embodiments of the present invention, a general authentication processing method using a PUF will be exemplified. In addition to the authentication processing method described here, for example, similar technologies are also disclosed by WO 2007072450 and WO 2008152564. Each of these technologies includes issues described below. By applying each of the embodiments of the present invention described below, the issues can be resolved.

[1-1: Operation of PUF]

First, the operation of a PUF will be described with reference to FIG. 1. FIG. 1 is an explanatory view showing the operation of a PUF. The PUF is a kind of arithmetic circuit that outputs a response value (response) to input of a challenge value (challenge). Each PUF has a property that regardless of how many times the same challenge value is input into the same PUF, the same response value is output from the PUF. Input/output characteristics of a PUF are determined by an element on which the PUF is mounted. Thus, PUFs that have the same configuration but are mounted in different ICs have different input/output characteristics. That is, if the same challenge value is input into PUFs of the same configuration mounted in different ICs, response values output from the two PUFs are different.

By using such a property, as shown in FIG. 1, an original IC (Original) and an illegally copied IC (Copy) can easily be distinguished.

For example, a predetermined challenge value (challenge) is input into an original IC to acquire a response value (response1) output from a PUF in advance. Then, when authentication processing is performed, the same challenge value (challenge) is input into an IC to be authenticated to acquire a response value (response′) output from the PUF of the IC. Then, the acquired response value (response′) and the response value (response1) acquired in advance are compared. If response′ and response1 match, authentication is established and if response′ and response1 do not match, authentication is not established. If the IC to be authenticated is an illegal copy IC (Copy), the acquired response value (response′=response1) is different from the response value (response1≠response2) acquired in advance. Thus, authentication thereof can be made not established by determining that the IC is an illegal copy IC.

[1-2: Authentication Processing Method Using Database and PUF]

A method as shown, for example, in FIG. 2 is devised as a general authentication processing method using the operation and characteristics of the PUF shown in FIG. 1. FIG. 2 is an explanatory view showing the authentication processing method (hereinafter, SD07) using a database and a PUF. SD07 will be described below.

The authentication processing method of SD07 is divided into a “registration phase” to register a challenge/response with the center and an “authentication phase” to authenticate an IC using the challenge/response registered in the registration phase. The center is, for example, a manufacturer of the IC or a trustworthy third party. Each challenge value is randomly generated by using, for example, a pseudo random number generator in the center. In the example in FIG. 2, it is assumed that N challenge values (chal₁, . . . , chal_{N}) are generated in advance by the center.

In the registration phase, a challenge value is first given to each IC from the center. For example, a challenge value (chalₖ) is given to the k-th IC (hereinafter, ICₖ; k=1, . . . , N). If the challenge value chalₖ is given, the ICₖ inputs the given challenge value chalₖ into the PUF to generate a response value (respₖ). The response value respₖ generated in this manner is acquired by the center. After acquiring response values (resp₁, . . . , resp_{N}) from all ICs, the center stores pairs of a response value to be acquired and a challenge value given to each IC in a database (DB). At this point, the center stores IDₖ (k=1, . . . , N) of each IC, the challenge value chalₖ, and the response value respₖ in the database by associating these values. In this manner, the database is constructed.

In the authentication phase, on the other hand, ID is first input to the terminal from an IC. For example, an ICₖ inputs an IDₖ into a terminal. When the IDₖ is input from the ICₖ, the terminal references the database to search for a record of the challenge/response corresponding to the IDₖ. Then, the terminal acquires the challenge/response (chalₖ, respₖ) detected by the search processing from the database. The terminal gives only the challenge value chalₖ to the ICₖ. The ICₖ inputs the provided challenge value chalₖ to the PUF to generate the response value respₖ. Then, the ICₖ provides the generated response value respₖ to the terminal.

When the response value respₖ is provided from the ICₖ, the terminal compares the provided response value respₖ and the response value respₖ acquired from the database to check whether the both response values respₖ match. Based on above-described PUF characteristics, the response values respₖ match if the ICₖ is original and the response values respₖ do not match if the ICₖ is an illegal copy. The response values respₖ do not match also when the IDₖ is erroneously input from an IC other than the ICₖ. Thus, if the response values respₖ match, the terminal establishes authentication by assuming that the ICₖ is the original ICₖ.

By adopting the configuration described above, even if the circuit configuration of ICₖ and content of a nonvolatile memory are illegally copied, an illegal IC can be prevented from being used. In this example, however, data of as many challenges/responses as the number of ICs is stored in the database. If only one pair of challenge/response is prepared for each IC, invalid authentication will be established when the response value respₖ is wiretapped on a transmission path and the illegally acquired response value respₖ is used. Thus, a method of changing the pair of challenge/response for each session is used.

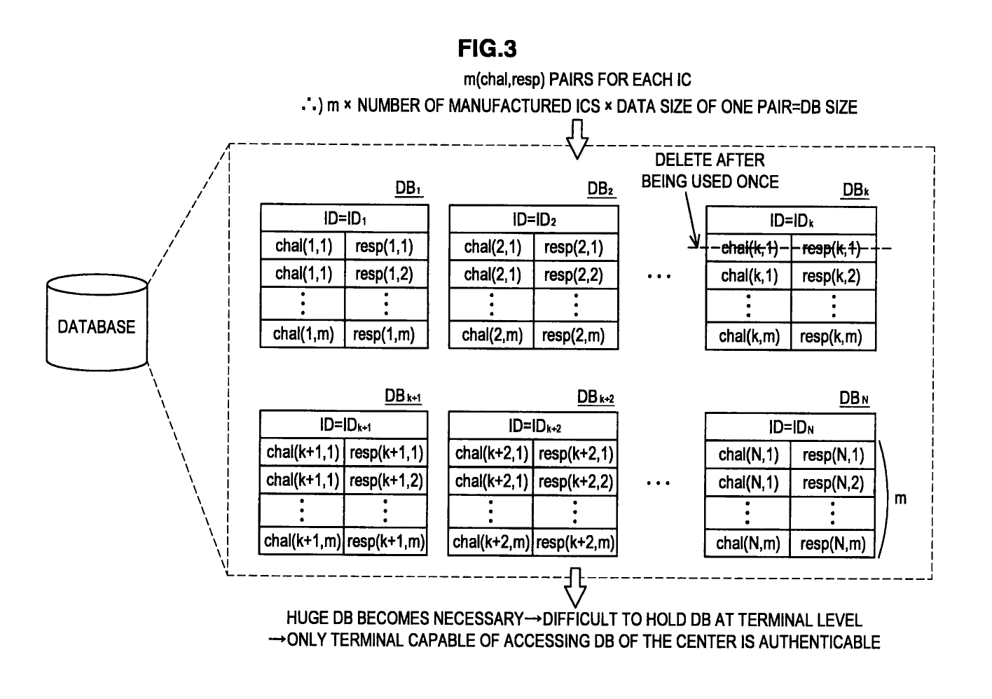

When this method is used, it is necessary to have a plurality of pairs of challenges/responses for each IC. Thus, the center generates a plurality of pairs of challenges/responses for each IC using a plurality of challenge values in the registration phase. Then, the center registers the generated challenges/responses with the database. With the registration processing described above, a database shown, for example, in FIG. 3 will be constructed. It is assumed, however, that the center inputs m challenge values into each IC and m pairs of challenges/responses are generated for each IC. The j-th challenge value corresponding to the ICₖ is denoted as chal(k, j) and the response value as resp(k, j). For the database illustrated in FIG. 3, the size thereof is determined by m×number of manufactured ICs×data size of one pair.

If, for example, data sizes of the ID, challenge value, and response value are each 128 bits, the total number of manufactured ICs is N=10,000,000, and the number of pairs is m, the size of a database will be 10,000,000×(m×(128+128)+128)≈(320m+160) MB. Therefore, the data size of a database will be about 32 GB if m=10 and about 320 GB if m==100. Each pair of challenge/response is deleted each time the pair is used for authentication processing. Thus, the number of pairs m corresponds to the number of times of authentication available for the IC. Therefore, it is necessary to actually set the number of pairs m to a larger number. Further, information of challenges/responses stored in the database is secret information to be used for authenticity establishment and should be controlled strictly as secrets.

For the above reason, only a center or the like is allowed to control a database like the above one. Consequently, only terminals capable of accessing a database like the above one controlled by a center or the like can use the above authentication method. Moreover, it is practically very difficult for an IC card, let alone a terminal to hold a huge database like the above one and thus, even if the terminal can access the database, it is very difficult to realize mutual authentication with the IC. As a result, it is unavoidable to say that it is substantially impracticable to realize mutual authentication by using the method of SD07.

(Flow of Authentication Processing by the SD07 Method)

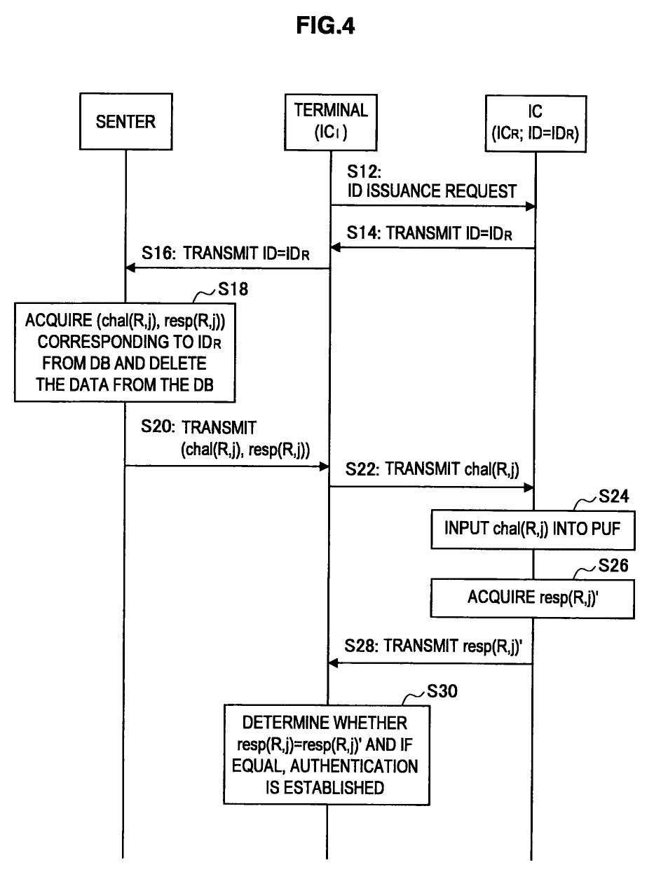

The flow of processing in the authentication phase according to the SD07 method will be described in more detail with reference to FIGS. 4 to 8.

First, FIG. 4 will be referenced. FIG. 4 is an explanatory view showing the flow of overall processing by the center, terminal, and IC in the authentication phase. Incidentally, the terminal may be denoted as IC_{I} and the IC as IC_{R}. The ID of the IC_{R} is set as ID_{R}. Further, the database is assumed to be controlled by the center.

In the authentication phase, an issuance request of ID is first sent to an IC from the terminal (S12). After receiving the issuance request of ID from the terminal, the IC sends the ID_{R}, which is the ID of the IC, to the terminal (S14). After receiving the ID_{R} from the IC, the terminal sends the received ID_{R} to the center (S16). After receiving the ID_{R} from the terminal, the center references the database to search for a record of the challenge/response corresponding to the ID_{R}. If, as shown in FIG. 3, a plurality of records exists for each ID, the center randomly selects a record from among records identified by the ID_{R} to acquire the challenge/response and deletes the record of the acquired challenge/response (S18).

If, for example, (chal(R, j), resp(R, j)) is acquired, the center sends (chal(R, j), resp(R, j)) to the terminal (S20). After receiving (chal(R, j), resp(R, j)) sent from the center, the terminal sends only chal(R, j) to the IC_{R} (S22). After receiving chal(R, j) sent from the terminal, the IC_{R} inputs the received challenge value chal(R, j) into the PUF (S24) and acquires a response value resp(R, j)′ from the PUF (S26). Next, the IC_{R} sends the acquired response value resp(R, j)′ to the terminal (S28).

After receiving the response value resp(R, j)′ from the IC_{R}, the terminal compares the received response value resp(R, j)′ and the response value resp(R, j) acquired from the center. If both the response values match, authentication is established and if both the response values do not match, authentication is not established (S30). The flow of authentication processing performed according to SD07 is as described above. In the example in FIG. 4, a record of the challenge/response used once is deleted at step S18 and thus, the authentication processing has resistance to replay attacks that attempt authentication by reusing a wiretapped response value. The example in FIG. 4 focuses on processing mutually performed among the center, terminal, and IC. Thus, the flow of processing performed individually by the center, terminal, and IC will be described below.

(Processing by the Terminal)

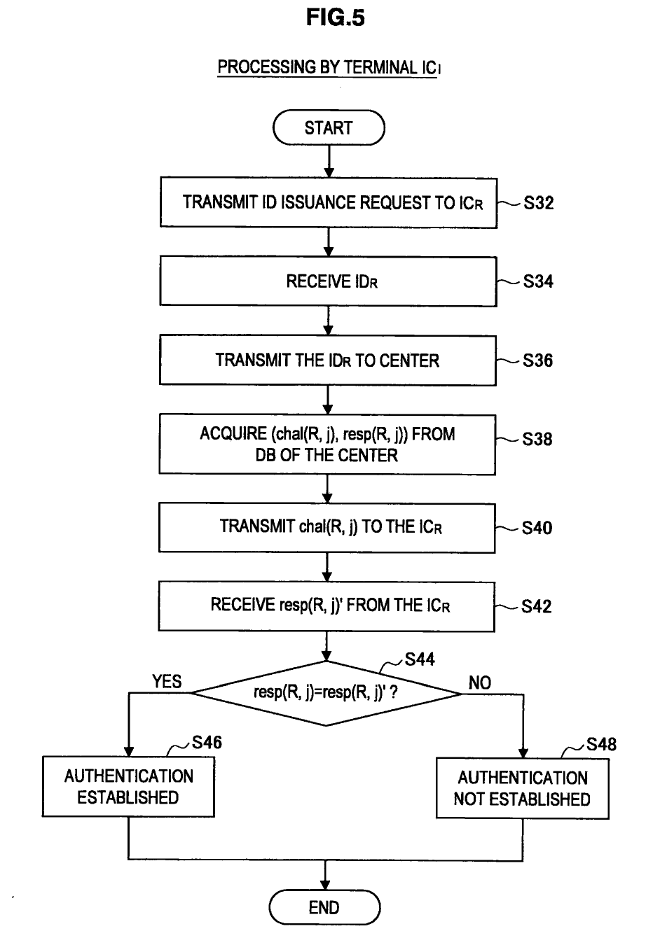

First, the flow of processing performed by the terminal in authentication processing according to SD07 will be described with reference to FIG. 5. As shown in FIG. 5, the terminal sends an ID issuance request to the IC_{R} (S32). Next, the terminal receives the ID_{R} from the IC_{R} as the ID (S34). Next, the terminal sends the ID_{R} received from the IC_{R} to the center (S36). Next, the terminal acquires the challenge/response (chal(R, j), resp(R, j)) stored in the database and corresponding to the ID_{R} from the center (S38). Next, the terminal sends the challenge value chal(R, j) to the IC_{R} (S40). Next, the terminal receives the response value resp(R, j)′ from the IC_{R} (S42).

Next, the terminal determines whether the response value resp(R, j) acquired from the center and the response value resp(R, j)′ acquired from the IC_{R} match (S44). If resp(R, j)=resp(R, j)′, the terminal establishes authentication (S46) and then terminates a sequence of authentication processing. If, on the other hand, resp(R, j)≠resp(R, j)′, the terminal does not establish authentication (S48) and performs error processing and then terminates a sequence of authentication processing. Thus, it is necessary for the terminal to access the database in the center to acquire the challenge/response used for authentication processing. Only the challenge value of the challenge/response acquired from the center is input into an IC and whether to establish authentication is determined by comparing the response value acquired from the IC with the response value acquired in advance.

(Processing by the IC)

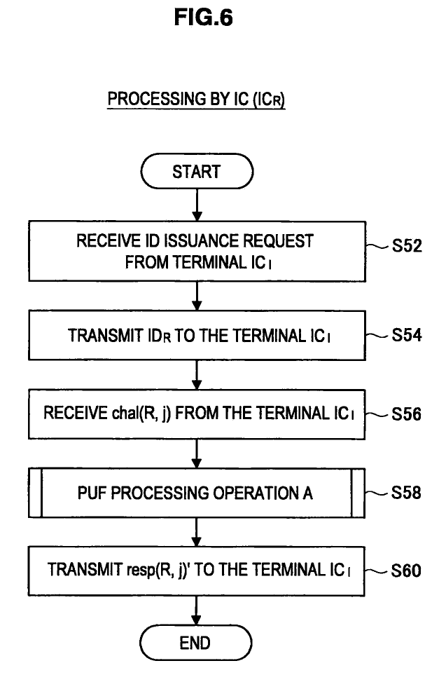

Next, the flow of processing performed by the IC(IC_{R}) in authentication processing according to SD07 will be described with reference to FIG. 6. As shown in FIG. 6, after receiving an ID issuance request from the terminal (S52), the IC_{R} sends the ID_{R}, which is the ID of the IC_{R}, to the terminal in accordance with the received issuance request (S54). Next, after receiving the challenge value chal(R, j) from the terminal (S56), the IC_{R} executes a PUF processing operation A described below to generate the response value resp(R, j)′ (S58). Then, the IC_{R} sends the response value resp(R, j)′ generated by the PUF processing operation A to the terminal (S60).

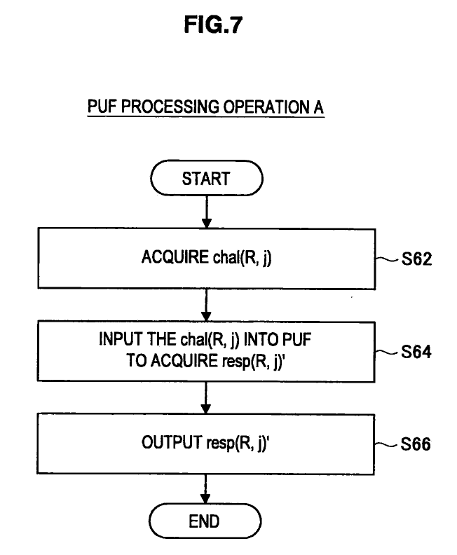

Here, processing of the PUF processing operation A will be described with reference to FIG. 7. After acquiring the challenge value chal(R, j) from the terminal at step S56 (S62), the IC_{R} inputs the acquired challenge value chal(R, j) into the PUF to acquire the response value resp(R, j)′ (S64). Next, the IC_{R} outputs the response value resp(R, j)′ acquired from the PUF as the response value resp(R, j)′ corresponding to the challenge value chal(R, j) (S66). Thus, main processing performed by the IC in the authentication phase is to generate the response value resp(R, j)′ by inputting the challenge value chal(R, j) received from the terminal into the PUF.

(Processing by the Center)

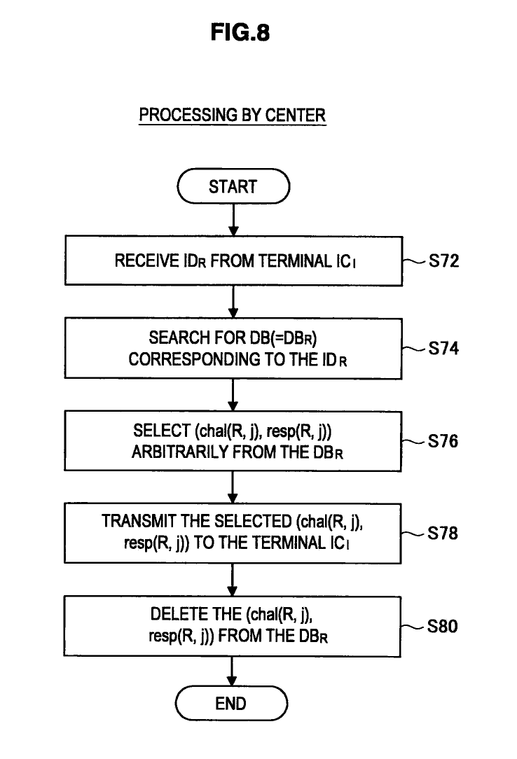

Next, the flow of processing performed by the center in authentication processing according to SD07 will be described with reference to FIG. 8. As shown in FIG. 8, after receiving the ID_{R}, which is the ID of the IC_{R}, from the terminal (S72), the center searches for a database DB_{R} corresponding to the ID_{R} (a set of records corresponding to the ID_{R}) (S74) and selects any challenge/response (chal(R, j), resp(R, j)) from the detected DB_{R} (S76). Next, the center sends the selected (chal(R, j), resp(R, j)) to the terminal (S78) and deletes the (chal(R, j), resp(R, j)) from the database (S80). Thus, resistance to replay attacks can be obtained by deleting the challenge/response used once.

According to the SD07 method, as has been described, a database in which pairs of challenges/responses for the PUF of each IC are stored is constructed in the registration phase and an illegally duplicated IC from being used by using the database in the authentication phase. However, if a database is used as described above in order to prevent an illegally duplicated IC from being used, the size of the database will become huge. Moreover, it is realistically impracticable to mount such a database in an IC and thus, mutual authentication using the SD07 method between the terminal and IC is not realizable.

Facing such issues, an authentication processing method capable of realizing prevention of an illegally duplicated IC from being used by using a PUF without constructing a huge database will be proposed in each embodiment described below. Moreover, it becomes possible to realize mutual authentication between a terminal and an IC by using the authentication processing method.

(About Mutual Authentication)

As already described, information stored in a database constructed in the registration phase is used when the terminal authenticates each IC in the authentication phase. If the SD07 method is used, as described above, the size of the database could become very huge. However, the center frequently holds a sufficient environment (computation capability, storage capability). Further, the terminal and the center are connected via a secure communication path. Thus, there is no need for the terminal to hold a database in secret to perform authentication. Therefore, while it is necessary for the center to hold a large-size database in secret, authentication of IC using the SD07 method is satisfactorily realizable.

However, when handling an IC card in which information of high value such as money information is stored, not only authentication of the IC card by the terminal, but also authentication of the terminal by the IC card is demanded. To realize mutual authentication by using the SD07 method, it is necessary to mount a PUF also on the IC of each terminal and to register pairs of challenges/responses generated for each terminal with the database. Further, it is necessary to construct a condition in which each IC card can freely access a database or to hold the database in each IC. The fact that it is unrealistic for the IC card to hold a database has been described. Moreover, the IC card can normally access a database in the center only via a terminal.

Therefore, when the center holds databases in secret, it is difficult for an IC card in a state in which authentication of a terminal is not established to access a database used for terminal authentication. Thus, now that it is very difficult to store a database in a nonvolatile memory of an IC card, it is very difficult to realize mutual authentication by using the SD07 method. Furthermore, even if a database can be stored in an IC card, the database itself will be duplicated if the circuit configuration and nonvolatile memory of the IC are duplicated so that mutual authentication is established by an illegally duplicated IC. As a result, it becomes difficult to achieve an original goal of preventing use of an illegally duplicated IC. Such issues can be resolved by using the authentication processing method of each embodiment described below.

### 2: First Embodiment

First, the first embodiment of the invention will be described. The present embodiment is devised in view of the above issues and provides a method capable of preventing an illegally duplicated IC from being used while mutual authentication between a terminal and an IC card being realized. The technology in the present embodiment is common to that of SD07 in that an illegally duplicated IC is prevented from being used by using PUF characteristics, but is significantly different in how to use the PUF. According to the SD07 method, as described above, authentication is established depending on whether the output value acquired in advance can be output again to the same input after predetermined input being input into the PUF mounted in the IC. If authentication is not established, an illegally duplicated IC is naturally prevented from being used because subsequent processing is discontinued.

According to the method in the present embodiment, on the other hand, while PUF characteristics are used, the output value of PUF itself is not judged and instead, authentication is performed depending on whether secret information encrypted by the output value of PUF can correctly be decrypted in the authentication phase. By adopting the configuration described above, the database that is indispensable to the method such as SD07 can be made unnecessary. Further, the amount of information that should be held by the IC can also be reduced. As a result, mutual authentication can be realized while an illegally duplicated IC is prevented from being used. The authentication processing method in the present embodiment having the above characteristics can be applied to various authentication processing methods and confirmation mechanisms of secret information or the like. A concrete example selected from among such methods will be described below.

PUFs that can be used to realize the technology in the present embodiment include, for example, a silicon PUF, optical PUF, and digital PUF. The silicon PUF uses fluctuations between semiconductor chips caused by the manufacturing process. The optical PUF uses unpredictability of spectral patterns generated when coherent light (for example, laser light) is radiated. As the optical PUF, for example, research results by P. S. Ravikanth “Physical One-Way Functions”, 2001 are known.

A description of the silicon PUF, on the other hand, can be found, for example, in “Silicon Physical Random Functions”, Proceedings of the 9th ACM Conference on Computer and Communications Security, November 2002 by Blaise Gassend et al. Naturally, in addition to these technologies, PUFs realized by other configurations that are available currently or in the future can also be used. Furthermore, in place of these PUFs, any arithmetic circuit whose input/output characteristics are determined, like PUFs, by physical characteristics specific to each element may be used.

[2-1: Functional Configuration of IC Card 200]

First, the functional configuration of the IC card 200 according to the first embodiment of the present invention will be described with reference to FIG. 9. Therein, the main functional configuration of the center 100 according to the present embodiment will also be described. FIG. 9 is an explanatory view showing the functional configuration of the IC card 200 according to the present embodiment.

As shown in FIG. 9, the IC card 200 mainly includes a key information acquisition unit 202, a response generation unit 204, a PUF 206, a storage unit 208, an encryption unit 210, a mutual authentication unit 212, a decryption unit 214, a shared key generation unit 216, and an encryption communication unit 218. The storage unit 208 corresponds to a nonvolatile memory provided in the IC card 200. The center 100 mainly includes a key information providing unit 102 and a storage unit 104.

The registration phase and the authentication phase also exist in the authentication processing method according to the present embodiment. Thus, the functional configuration of the IC card 200 will be described below separately for each phase. However, no database is constructed in the registration phase according to the present embodiment and instead, a challenge value (chal) and secret information (mk) common to each IC are provided. Then, a response value resp corresponding to the challenge value chal is generated by each IC and the secret information mk is encrypted using the response value resp as a key. Cipher text C=Eᵣₑₛₚ(mk) generated by the encryption processing is stored in the nonvolatile memory of each IC together with the challenge value chal. E_{A}(B) means cipher text obtained by encrypting B using a key A. E_{A}(B) may also be denoted as E(A, B).

In the authentication phase according to the present embodiment, on the other hand, each IC reads cipher text C and the challenge value chal stored in the nonvolatile memory by each IC and inputs the challenge value chal into the PUF 206 to generate the response value resp. Then, in the present embodiment, each IC decrypts the cipher text C using the generated resp and performs encryption communication using the secret information mk obtained by decrypting the cipher text C. As a result, it is difficult for an illegally duplicated IC to obtain the correct secret information mk, making it difficult to perform encryption communication. In the present embodiment, by using the method described above, mutual authentication is made realizable without using any database while an illegally duplicated IC is prevented from being used.

(Functional Configuration Concerning the Registration Phase)

First, the functional configuration of the IC card 200 concerning the registration phase will be described. In the registration phase, the challenge value chal and the system secret information mk that are common throughout the system are first provided from the center 100 to the IC card 200. The challenge value chal provided in the present embodiment is not different for each IC and instead, is common throughout the whole system including the center 100, the IC card 200, and the IC card user terminal 300 described below. Similarly, the system secret information mk provided in the present embodiment is not different for each IC and instead, is common throughout the whole system including the center 100, the IC card 200, and the IC card user terminal 300 described below.

The challenge value chal and the system secret information mk are stored in the storage unit 104 held by the center 100. In the registration phase, the challenge value chal and the system secret information mk are read by the key information providing unit 102 held by the center 100 from the storage unit 104 and provided to each of the IC cards 200. The challenge value chal and the system secret information mk provided by the center 100 are acquired by the key information acquisition unit 202 held by the IC card 200. Then, the challenge value chal acquired by the key information acquisition unit 202 is stored in the storage unit 208. The system secret information mk acquired by the key information acquisition unit 202 is input into the encryption unit 210.

Further, the challenge value chal stored in the storage unit 208 is read by the response generation unit 204 and input into the PUF 206. The PUF 206 generates the response value resp to the challenge value chal input from the response generation unit 204. Note that the response value resp output from the PUF 206 is specific to the IC card 200. The response value resp generated by the PUF 206 is input into the response generation unit 204. After the response value resp being generated in this manner, the response generation unit 204 inputs the response value resp into the encryption unit 210.

As described above, system secret information from the key information acquisition unit 202 is input into the encryption unit 210 and also the response value resp from the response generation unit 204 is input into the encryption unit 210. Then, the encryption unit 210 encrypts the system secret information mk by using the input response value resp as a key. The cipher text C=Eᵣₑₛₚ(mk) is generated by the encryption processing. The cipher text C generated by the encryption unit 210 is stored in the storage unit 208. Processing up to this point is performed in the registration phase. After the above processing, the storage unit 208 of the IC card 200 has the challenge value chal and the cipher text C stored therein. Note that the system secret information mk is not held inside the IC card 200.

(Functional Configuration Concerning the Authentication Phase)

Next, the functional configuration of the IC card 200 concerning the authentication phase will be described. In the authentication phase, mutual authentication is first performed between the IC card 200 and the IC card user terminal 300. It is assumed that a mutual authentication key Kₐᵤₜₕ used for mutual authentication is stored in the storage unit 208. Thus, the mutual authentication unit 212 reads the mutual authentication key Kₐᵤₜₕ from the storage unit 208 and establishes mutual authentication with the IC card user terminal 300 by using the mutual authentication key Kₐᵤₜₕ. Then, after the mutual authentication being established, the mutual authentication unit 212 acquires a session key Kₛₑₛ used to establish a session with the IC card user terminal 300. The session key Kₛₑₛ acquired by the mutual authentication unit 212 is input into the shared key generation unit 216.

In the authentication phase, after mutual authentication with the IC card user terminal 300 being realized, generation processing of a shared key K used to realize encryption communication with the IC card user terminal 300 is performed. First, the challenge value chal is read by the response generation unit 204 from the storage unit 208. Then, the response generation unit 204 inputs the challenge value chal read from the storage unit 208 into the PUF 206. The PUF 206 generates the response value resp to the challenge value chal input from the response generation unit 204. Then, the response value resp generated by the PUF 206 is input into the response generation unit 204. In this manner, the response value resp acquired by the response generation unit 204 by using the PUF 206 is input into the decryption unit 214.

While a description is given here that the response value resp is generated by the PUF 206, if the IC card 200 is an illegally duplicated IC, a response value resp′ (≠resp) is generated by the PUF 206. The IC card 200 that generated the response value resp in the registration phase is an original IC assumed by the center 100. In the IC card 200 generated by illegal duplication of the IC card 200, on the other hand, the same configuration including the cipher text C and the challenge value chat stored in the storage unit 208 is reproduced. However, the original IC and the illegally duplicated IC do differ in input/output characteristics of the PUF 206. Thus, an IC can be distinguished between an original IC and an illegally duplicated IC each time authentication is performed by the PUF 206 being caused to generate the response value resp again by the response generation unit 204 in a authentication phase. The description will further proceed with this being kept in mind. However, the IC card 200 is assumed to be an original IC in the description that follows.

When the response value resp is input from the response generation unit 204, the decryption unit 214 reads the cipher text C=Eᵣₑₛₚ(C) from the storage unit 208. Then, the decryption unit 214 decrypts the cipher text C by using the response value resp input from the response generation unit 204 as a key. The system secret information mk restored by the decryption processing is input into the shared key generation unit 216. If the response value input from the response generation unit 204 is different from that used when the cipher text C was generated, the correct system secret information mk is not restored. That is, an original IC and an illegally duplicated IC can be distinguished based on whether or not the system secret information restored by the decryption unit 214 is correct.

When the system secret information mk is input from the decryption unit 214, the shared key generation unit 216 generates the shared key K by combining the session key Kₛₑₛ input from the mutual authentication unit 212 and the system secret information mk input from the decryption unit 214. For example, the shared key generation unit 216 generates the shared key K=H(Kₛₑₛ∥mk) by using a hash function H( . . . ). Incidentally, A∥B means linking of A and B. Naturally, the shared key K may be generated by combining the system secret information mk and the session key Kₛₑₛ by another predetermined method. Note that the above method of using a hash function H is an example and any other method can be applied to the present embodiment.

The shared key K generated by the shared key generation unit 216 is input into the encryption communication unit 218. The encryption communication unit 218 performs encryption communication with the IC card user terminal 300 by using the shared key K input from the shared key generation unit 216. If the correct system secret information mk is not restored by the decryption unit 214, it is difficult for the encryption communication unit 218 to perform encryption communication because the correct shared key K is not input into the encryption communication unit 218. For example, it is difficult for the encryption communication unit 218 to decrypt acquired cipher text. Further, it is difficult for the IC card user terminal 300 to decrypt cipher text sent by the encryption communication unit 218. Therefore, if the IC card 200 is an illegally duplicated IC, even if mutual authentication with the IC card user terminal 300 is established, encryption communication to actually read/write information of the IC card 200 becomes unrealizable.

[2-2: Functional Configuration of IC Card User Terminal 300]

Next, the functional configuration of the IC card user terminal 300 according to the present embodiment will be described with reference to FIG. 10. FIG. 10 is an explanatory view showing the functional configuration of the IC card user terminal 300 according to the present embodiment. In the present embodiment, mutual authentication between the IC card 200 and the IC card user terminal 300 is assumed and thus, substantially the same functional configuration is also provided in the IC card user terminal 300 as that in the IC card 200.

Therefore, as shown in FIG. 10, the IC card user terminal 300 mainly includes a key information acquisition unit 302, a response generation unit 304, a PUF 306, a storage unit 308, an encryption unit 310, a mutual authentication unit 312, a decryption unit 314, a shared key generation unit 316, and an encryption communication unit 318. The storage unit 308 corresponds to a nonvolatile memory.

(Functional Configuration Concerning the Registration Phase)

First, the functional configuration of the IC card user terminal 300 concerning the registration phase will be described. In the registration phase, the challenge value chal and the system secret information mk that are common throughout the system are first provided from the center 100 to the IC card user terminal 300. As described above, the challenge value chal provided in the present embodiment is common throughout the whole system including the center 100, the IC card 200, and the IC card user terminal 300 described below. Similarly, the system secret information mk provided in the present embodiment is common throughout the whole system including the center 100, the IC card 200, and the IC card user terminal 300 described below.

The challenge value chal and the system secret information mk are stored in the storage unit 104 held by the center 100. In the registration phase, the challenge value chal and the system secret information mk are read by the key information providing unit 102 held by the center 100 from the storage unit 104 and provided to each of the IC card user terminals 300. The challenge value chal and the system secret information mk provided by the center 100 are acquired by the key information acquisition unit 302 held by the IC card user terminals 300. Then, the challenge value chal acquired by the key information acquisition unit 302 is stored in the storage unit 308. The system secret information mk acquired by the key information acquisition unit 302 is stored in the encryption unit 310.

Further, the challenge value chal stored in the storage unit 308 is read by the response generation unit 304 and input into the PUF 306. The PUF 306 generates the response value resp to the challenge value chal input from the response generation unit 304. The response value resp output from the PUF 306 is specific to the IC card user terminals 300. Note that the response value resp is naturally different from the above response value resp generated in the IC card 200. The response value resp generated by the PUF 306 is input into the response generation unit 304. After the response value resp being generated by using the PUF 306, the response generation unit 304 inputs the response value resp into the encryption unit 310.

As described above, system secret information from the key information acquisition unit 302 is input into the encryption unit 310 and also the response value resp from the response generation unit 304 is input into the encryption unit 310. Then, the encryption unit 310 encrypts the system secret information mk by using the input response value resp as a key. The cipher text C=Eᵣₑₛₚ(mk) is generated by the encryption processing. The cipher text C generated by the encryption unit 310 is stored in the storage unit 308. Processing up to this point is performed in the registration phase. After the above processing, the storage unit 308 of the IC card user terminals 300 has the challenge value chal and the cipher text C stored therein. Note that the system secret information mk is not held inside the IC card user terminals 300.

(Functional Configuration Concerning the Authentication Phase)

Next, the functional configuration of the IC card user terminals 300 concerning the authentication phase will be described. In the authentication phase, mutual authentication is first performed between the IC card user terminal 300 and the IC card 200. It is assumed that the mutual authentication key Kₐᵤₜₕ used for mutual authentication is stored in the storage unit 308. Thus, the mutual authentication unit 312 reads the mutual authentication key Kₐᵤₜₕ from the storage unit 308 and causes mutual authentication with the IC card 200 to be established by using the mutual authentication key Kₐᵤₜₕ. Then, after the mutual authentication being established, the mutual authentication unit 312 acquires the session key Kₛₑₛ used to establish a session with the IC card 200. The session key Kₛₑₛ acquired by the mutual authentication unit 312 is input into the shared key generation unit 316.

In the authentication phase, after mutual authentication with the IC card 200 being realized, generation processing of the shared key K used to realize encryption communication with the IC card 200 is performed. First, the challenge value chal is read by the response generation unit 304 from the storage unit 308. Then, the response generation unit 304 inputs the challenge value chal read from the storage unit 308 into the PUF 306. The PUF 306 generates the response value resp to the challenge value chal input from the response generation unit 304. Then, the response value resp generated by the PUF 306 is input into the response generation unit 304. In this manner, the response value resp acquired by the response generation unit 304 by using the PUF 306 is input into the decryption unit 314. In the description that follows, the IC card user terminal 300 is assumed to be original.

When the response value resp is input from the response generation unit 304, the decryption unit 314 reads the cipher text C=Eᵣₑₛₚ(C) from the storage unit 308. Then, the decryption unit 314 decrypts the cipher text C by using the response value resp input from the response generation unit 304 as a key. The system secret information mk restored by the decryption processing is input into the shared key generation unit 316. If the response value input from the response generation unit 304 is different from that used when the cipher text C was generated, the correct system secret information mk is not restored.

When the system secret information mk is input from the decryption unit 314, the shared key generation unit 316 generates the shared key K by combining the session key Kₛₑₛ input from the mutual authentication unit 312 and the system secret information mk input from the decryption unit 314. For example, the shared key generation unit 316 generates the shared key K=H(Kₛₑₛ∥mk) by using a hash function H( . . . ). Naturally, the shared key K may be generated by combining the system secret information mk and the session key Kₛₑₛ by another predetermined method. Note that the above method of using a hash function H is an example and any other method can be applied to the present embodiment. However, it is necessary to pay attention to the fact that the shared key K is generated by the same predetermined method as that used for the IC card 200.

The shared key K generated by the shared key generation unit 316 is input into the encryption communication unit 318. The encryption communication unit 318 performs encryption communication with the IC card 200 by using the shared key K input from the shared key generation unit 316. If the correct system secret information mk is not restored by the decryption unit 314, it is difficult for the encryption communication unit 318 to perform encryption communication because the correct shared key K is not input into the encryption communication unit 318. Therefore, if the IC card user terminal 300 is an illegally duplicated IC card user terminal, even if mutual authentication is established with the IC card 200, encryption communication to actually read/write information of the IC card 200 becomes unrealizable.

In the foregoing, the functional configurations of the IC card 200 and the IC card user terminal 300 have been described. The above functional configurations are only examples and, for example, the method of mutual authentication, the method used for encryption communication and the like may be changed if appropriate. As already described, technical features of the present embodiment are that the IC card 200 and the IC card user terminal 300 restore the system secret information mk by successively generating response values in the authentication phase and use correctness thereof to determine whether an IC card or IC card user terminal is original. Therefore, as long as a substantive portion of such technical features is not changed, the configuration can optionally be changed. Moreover, even if such a change is made, the configuration after the change can be said to belong to the technical scope of the present embodiment.

[2-3: Processing in Registration Phase]

Next, the flow of processing performed in the registration phase will be described with reference to FIGS. 11 and 12. FIG. 11 is an explanatory view showing the overall flow of processing performed in the registration phase. FIG. 12, on the other hand, is an explanatory view showing the flow of processing concerning a portion using a PUF.

First, FIG. 11 will be referenced. As shown in FIG. 11, the center 100 first sets a parameter k showing each IC to 0 (S102). For convenience of description, the IC card 200 or the IC card user terminal 300 may simply be denoted as the IC in the description that follows. The index to distinguish each IC may also be attached to represent the IC as ICₖ or the like. Next, the center 100 increments the parameter k by 1 (S104). Next, the center 100 determines whether k≦N holds with reference to the number N of manufactured ICs (S106). If k≦N holds, the center 100 proceeds to processing at step S108. On the other hand, if k≦N does not hold, the center 100 terminates a sequence of processing.

If processing proceeds to step S108, the center 100 inputs the challenge value chal and the system secret information mk common throughout the system by specifying the IDₖ, which is the ID of the ICₖ, for the ICₖ (S108). Next, a PUF processing operation B described below is executed in the ICₖ into which the challenge value chal and the system secret information mk were input from the center 100 (S110). When the PUF processing operation B is executed, an increment operation of the parameter k is performed (S104) by the center 100 after returning to processing at step S104 to repeat subsequent processing steps.

Next, FIG. 12 will be referenced. FIG. 12 shows processing steps of the PUF processing operation B in detail. As shown in FIG. 12, the ICₖ first acquires the IDₖ, challenge value chat, and system secret information mk from the center 100 (S112). Next, the ICₖ inputs the challenge value chal into the PUF to acquire a response value respₖ (S114). In the description that follows, an index k is attached like respₖ to indicate a response value acquired by the PUF of the ICₖ. Next, the ICₖ encrypts the system secret information mk using the acquired response value respₖ as a key to compute the cipher text Cₖ=Eᵣₑₛₚₖ(mk) (S116). Then, the ICₖ stores the IDₖ, challenge value chal, and response value Cₖ in a nonvolatile memory (S118) and then terminates the processing steps of the PUF processing operation B.

As described above, with processing being performed according to the flow shown in FIGS. 11 and 12, the challenge value chat and cipher text Cₖ are stored in the storage unit 208 of the IC card 200 and the storage unit 308 of the IC card user terminal 300 corresponding to the ICₖ. The ID (=IDₖ) issued by the center 100 is also stored in the storage units 208 and 308 in the registration phase.

[2-4: Processing in Authentication Phase]

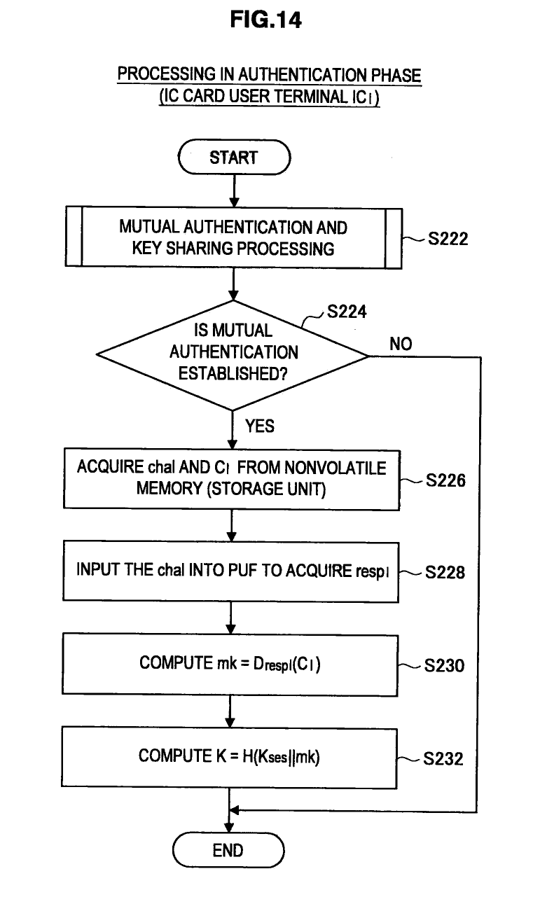

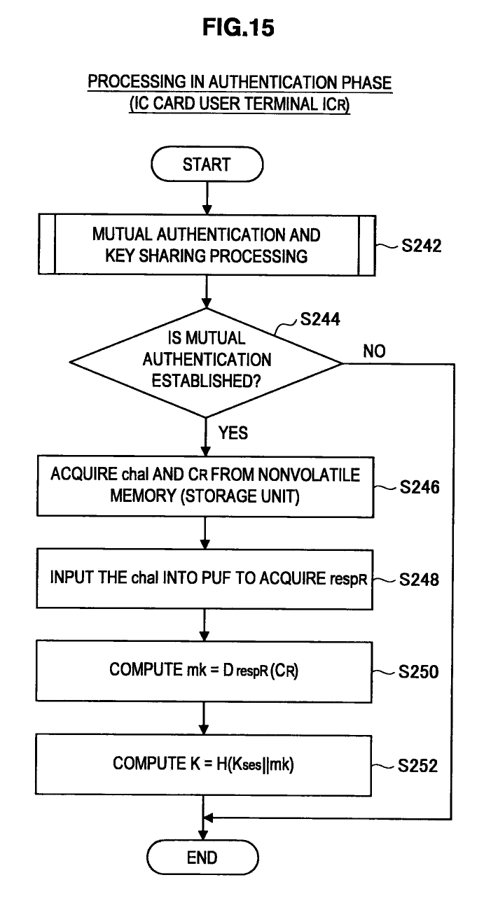

Next, the flow of processing performed in the authentication phase will be described with reference to FIGS. 13 to 15. In the description thereof, processing between the IC card user terminal 300 and the IC card 200 in the authentication phase is assumed. The IC card user terminal 300 may be denoted as an IC_{I} and the IC card 200 as an IC_{R}. FIG. 13 is an explanatory view showing the overall flow of processing including exchanges between the IC card user terminal 300 and the IC card 200 in the authentication phase. FIG. 14 is an explanatory view showing the flow of processing performed mainly in the IC card user terminal 300. FIG. 15 is an explanatory view showing the flow of processing performed mainly in the IC card 200.

First, FIG. 13 will be referenced. As shown in FIG. 13, mutual authentication processing between the IC card user terminal 300 and the IC card 200 is first performed (S202). At this point, if mutual authentication is established, the session key Kₛₑₛ used when a session is established is shared by the IC card user terminal 300 and the IC card 200. The authentication performed at this step is established even if one or both of the IC card user terminal 300 and the IC card 200 are illegally duplicated. Thus, the processing described below is performed in the IC card user terminal 300 and the IC card 200.

First, when mutual authentication (S202) is established, the IC card user terminal 300 inputs the challenge value chal into the PUF to acquire a response value resp_{I} (S204). Then, the IC card user terminal 300 decrypts cipher text C_{I} using the acquired response value resp_{I} to restore the system secret information mk (S206). D_{A}(B) means that decryption processing is performed on cipher text B by using a key A. Note that if the acquired response value resp_{I} is not correct, the correct system secret information mk is not restored. After the system secret information mk being restored, the IC card user terminal 300 computes the shared key K=H(Kₛₑₛ∥mk) used for encryption communication (S208).

Similarly, when mutual authentication (S202) is established, the IC card 200 inputs the challenge value chal into the PUF to acquire a response value resp_{R} (S210). Then, the IC card 200 decrypts cipher text C_{R} using the acquired response value resp_{R} to restore the system secret information mk (S212). Note that if the acquired response value resp_{R} is not correct, the correct system secret information mk is not restored. After the system secret information mk being restored, the IC card 200 computes the shared key K=H(Kₛₑₛ∥mk) used for encryption communication (S214). When the shared key K is shared in this manner, encryption communication using the shared key K is performed between the IC card user terminal 300 and the IC card 200 (S216).

In the foregoing, the overall flow of processing concerning a system in the authentication phase has been described. The flow of processing performed individually by the IC card user terminal 300 and the IC card 200 will be described below in more detail.

First, FIG. 14 will be referenced. As shown in FIG. 14, after mutual authentication and sharing processing of a session key being performed with the IC card 200 (S222), the IC card user terminal 300 determines whether mutual authentication is established (S224). If mutual authentication is established, the IC card user terminal 300 proceeds to processing at step S226. If, on the other hand, mutual authentication is not established, the IC card user terminal 300 terminates a sequence of processing by considering authentication as not established. If processing proceeds to step S226, the IC card user terminal 300 acquires the challenge value chal and cipher text C_{I} from the storage unit 308 (S226).

Next, the IC card user terminal 300 inputs the challenge value chal into the PUF 306 to acquire the response value resp_{I} (S228). Next, the IC card user terminal 300 decrypts the cipher text C_{I} by using the acquired response value resp_{I} to acquire the system secret information mk (S230). Next, the IC card user terminal 300 generates the shared key K by using the session key Kₛₑₛ shared at step S222 and the system secret information mk restored from the cipher text C_{I} (S232).

If the IC card user terminal 300 should be an illegally duplicated IC, the response value resp_{I} acquired at step S228 is different from the legal one and thus, the correct system secret information mk is not restored at step S230. Therefore, the correct shared key K is not computable at step S232, leading to failed encryption communication. As a result, even if mutual authentication is established at step S222 by illegal duplication attacks, it is very difficult to illegally read/write information in the IC card 200 or to illegally read/write information in the IC card user terminal 300.

Next, FIG. 15 will be referenced. As shown in FIG. 15, after mutual authentication and sharing processing of a session key being performed with the IC card user terminal 300 (S242), the IC card 200 determines whether mutual authentication is established (S244). If mutual authentication is established, the IC card 200 proceeds to processing at step S246. If, on the other hand, mutual authentication is not established, the IC card 200 terminates a sequence of processing by considering authentication as not established.

If processing proceeds to step S246, the IC card 200 acquires the challenge value chal and cipher text C_{R} from the storage unit 208 (S246). Next, the IC card 200 inputs the challenge value chal into the PUF 206 to acquire the response value resp_{R} (S248). Next, the IC card 200 decrypts the cipher text C_{R} by using the acquired response value resp_{R} to acquire the system secret information mk (S250). Next, the IC card 200 generates the shared key K by using the session key Kₛₑₛ shared at step S242 and the system secret information mk restored from the cipher text C_{R} (S252).

If the IC card 200 should be an illegally duplicated IC, the response value resp_{R} acquired at step S248 is different from the legal one and thus, the correct system secret information mk is not restored at step S250. Therefore, the correct shared key K is not computable at step S252, leading to failed encryption communication. As a result, even if mutual authentication is established at step S242 by illegal duplication attacks, it is very difficult to illegally read/write information in the IC card 200 or to illegally read/write information in the IC card user terminal 300.

As is described in the foregoing, by using the authentication processing method according to the present embodiment, tampering by an illegally duplicated IC can be prevented by making the most of PUF characteristics. According to the authentication processing method, there is no need for a database like in the SD07 method. For example, one challenge value suffices because a challenge value common throughout the system can be used. Response values are generated during execution in the registration phase and during execution in the authentication phase and are held neither on the IC nor in the center after being used for encryption or decryption. Thus, the number of response values that should continuously be held is 0. Information that should be held by each IC in the nonvolatile memory is a piece of cipher text and one challenge value. Therefore, such information can easily be stored in the nonvolatile memory mounted in a normal IC. As a result, mutual authentication between a terminal and an IC can be realized while illegal duplication attacks being prevented.

(Supplementary Explanation)

The above nonvolatile memory (the storage units 208 and 308) can be realized by a semiconductor recording medium such as an EEPROM and flash memory. A PROM realized by chip morphing technology that combines a soft algorithm and a microscopic electric fuse can also be used as the storage units 208 and 308. The EEPROM is an abbreviation of Electrically Erasable and Programmable Read Only Memory. The PROM is an abbreviation of Programmable Read Only Memory. The mutual authentication key Kₐᵤₜₕ used in the authentication phase may be stored by using a wiring structure of the IC in advance or in a nonvolatile memory. The mutual authentication key Kₐᵤₜₕ may also be the one provided by the center 100 in the registration phase. The above authentication processing method is an example in which encryption communication by the shared key encryption system is performed in the end is assumed, but it is possible to change to a method that assumes encryption communication by the public key encryption system. It is needless to say that such modifications are also included in the technical scope of the present embodiment.

In the foregoing, technology according to the first embodiment has been described in detail. By applying technology according to the first embodiment, mutual authentication between a terminal and an IC can be realized while an illegally duplicated IC is prevented from being used. A sufficiently secure system having such an effect can be constructed by applying the technology, but a more secure system can also be realized by providing some contrivance. Technology invented for further enhancement of security will be described below.

### 3: Second Embodiment

In the first embodiment, as described above, an illegally duplicated IC is prevented from correctly performing encryption communication by devising the configuration of the shared key K computed by using the session key Kₛₑₛ and the system secret information mk after mutual authentication. If encryption communication is performed by using a different shared key K, it is normally inconceivable that a value obtained by decryption of cipher text becomes some meaningful value (for example, a command or the like). Thus, by applying technology in the first embodiment, an illegally duplicated IC can realistically be prevented from being used adequately.

However, from the viewpoint of security enhancement, it is preferable to perform encryption communication after mutually making sure that the correct shared key is shared with the communication partner. That is, a configuration in which whether the shared key is authentic is determined before cipher text received from an illegally duplicated IC is decrypted is preferable. Thus, a configuration in which key matching is checked after mutual authentication being established is proposed as the second embodiment. By applying such a configuration, security can be enhanced by saving cipher text generated by an illegally duplicated IC from being decrypted.

The second embodiment described below is obtained by adding a key matching verification phase before encryption communication being performed in the above authentication phase of the first embodiment. The key matching verification phase is a processing step to check whether the same shared key as that of the communication partner is held by a predetermined method. For convenience of description, an example of concrete processing content is described below, but the method can be changed to any method capable of determining whether the shared key is correctly shared. That is, note that concrete processing content in the key matching verification phase can be replaced by any method having the same purpose.

[3-1: Functional Configuration of IC Card 230]

First, the functional configuration of the IC card 230 according to the second embodiment of the present invention will be described with reference to FIG. 16. However, the same reference numerals are attached to components having substantially the same functions as those of the IC card 200 according to the first embodiment described above to omit a detailed description thereof. FIG. 16 is an explanatory view of the functional configuration of the IC card 230 according to the present embodiment.

As shown in FIG. 16, the IC card 230 mainly includes the key information acquisition unit 202, the response generation unit 204, the PUF 206, the storage unit 208, the encryption unit 210, the mutual authentication unit 212, the decryption unit 214, the shared key generation unit 216, the encryption communication unit 218, and a key matching verification unit 232. Therefore, the main difference from the IC card 200 according to the first embodiment described above is the presence of the key matching verification unit 232. The functional configuration and processing content concerning the registration phase are substantially the same as those of the IC card 200 according to the first embodiment described above. Thus, the description of the functional configuration and processing content concerning the registration phase is omitted.

(Functional Configuration Concerning the Authentication Phase)

Thus, the functional configuration of the IC card 230 concerning the authentication phase will be described. In the authentication phase, mutual authentication is first performed between the IC card 230 and the IC card user terminal 330. The mutual authentication unit 212 reads the mutual authentication key Kₐᵤₜₕ from the storage unit 208 and causes mutual authentication with the IC card user terminal 330 to be established by using the mutual authentication key Kₐᵤₜₕ. Then, after the mutual authentication being established, the mutual authentication unit 212 acquires the session key Kₛₑₛ used to establish a session with the IC card user terminal 330. The session key Kₛₑₛ acquired by the mutual authentication unit 212 is input into the shared key generation unit 216.

In the authentication phase, after mutual authentication with the IC card user terminal 330 being realized, generation processing of the shared key K used to realize encryption communication with the IC card user terminal 330 is performed. First, the challenge value chal is read by the response generation unit 204 from the storage unit 208. Then, the response generation unit 204 inputs the challenge value chal read from the storage unit 208 into the PUF 206. The PUF 206 generates the response value resp to the challenge value chal input from the response generation unit 204. Then, the response value resp generated by the PUF 206 is input into the response generation unit 204. In this manner, the response value resp acquired by the response generation unit 204 by using the PUF 206 is input into the decryption unit 214.

When the response value resp is input from the response generation unit 204, the decryption unit 214 reads the cipher text C=Eᵣₑₛₚ(mk) from the storage unit 208. Then, the decryption unit 214 decrypts the cipher text C by using the response value resp input from the response generation unit 204 as a key. The system secret information mk restored by the decryption processing is input into the shared key generation unit 216. When the system secret information mk is input from the decryption unit 214, the shared key generation unit 216 generates the shared key K by combining the session key Kₛₑₛ input from the mutual authentication unit 212 and the system secret information mk input from the decryption unit 214.

The shared key K generated by the shared key generation unit 216 is input into the key matching verification unit 232. The key matching verification unit 232 checks whether the shared key K input from the shared key generation unit 216 and the shared key K held by the IC card user terminal 330 match by a predetermined method. As the predetermined method, various methods including a method using MAC operations of random numbers and a method using digital signatures can be considered. The above MAC is an abbreviation of Message Authentication Code. If the key matching verification unit 232 verifies matching of the shared keys K, the shared key K is input into the encryption communication unit 218 from the key matching verification unit 232. If, on the other hand, key matching verification fails, the key matching verification unit 232 terminates authentication processing by outputting an error message.

Then, the encryption communication unit 218 performs encryption communication with the IC card user terminal 330 by using the shared key K input from the key matching verification unit 232. If the correct system secret information mk is not restored by the decryption unit 214, it is difficult for the encryption communication unit 218 to perform encryption communication because key matching verification fails in the key matching verification unit 232. Therefore, if the IC card 230 is an illegally duplicated IC or the IC card user terminal 330 is an illegally duplicated IC, even if mutual authentication with the IC card user terminal 330 is established, encryption communication to actually read/write information of the IC card 230 becomes unrealizable.

If it is known that the IC card user terminal 330 is a legal IC, it becomes possible to identify the IC card 230 that failed in key matching verification so that the IC card 230 that may be an illegally duplicated IC can easily be found. Conversely, if it is known that the IC card 230 is a legal IC, it becomes possible to identify the IC card user terminal 330 that failed in key matching verification so that the IC card user terminal 330 that may be an illegally duplicated IC can easily be found.

[3-2: Functional Configuration of IC Card User Terminal 330]

Next, the functional configuration of the IC card user terminal 330 according to the second embodiment of the present invention will be described with reference to FIG. 17. However, the same reference numerals are attached to components having substantially the same functions as those of the IC card user terminal 300 according to the first embodiment described above to omit a detailed description thereof. FIG. 17 is an explanatory view showing the functional configuration of the IC card user terminal 330 according to the present embodiment.

As shown in FIG. 17, the IC card user terminal 330 mainly includes the key information acquisition unit 302, the response generation unit 304, the PUF 306, the storage unit 308, the encryption unit 310, the mutual authentication unit 312, the decryption unit 314, the shared key generation unit 316, the encryption communication unit 318, and a key matching verification unit 332. Therefore, the main difference from the IC card user terminal 300 according to the first embodiment described above is the presence of the key matching verification unit 332. The functional configuration and processing content concerning the registration phase are substantially the same as those of the IC card user terminal 300 according to the first embodiment described above. Thus, the description of the functional configuration and processing content concerning the registration phase is omitted.

(Functional Configuration Concerning the Authentication Phase)

Thus, the functional configuration of the IC card user terminals 330 concerning the authentication phase will be described. In the authentication phase, mutual authentication is first performed between the IC card user terminal 330 and the IC card 230. The mutual authentication unit 312 reads the mutual authentication key Kₐᵤₜₕ from the storage unit 308 and causes mutual authentication with the IC card 230 to be established by using the mutual authentication key Kₐᵤₜₕ. Then, after the mutual authentication being established, the mutual authentication unit 312 acquires the session key Kₛₑₛ used to establish a session with the IC card 230. The session key Kₛₑₛ acquired by the mutual authentication unit 312 is input into the shared key generation unit 316.

In the authentication phase, after mutual authentication with the IC card 230 being realized, generation processing of the shared key K used to realize encryption communication with the IC card 230 is performed. First, the challenge value chal is read by the response generation unit 304 from the storage unit 308. Then, the response generation unit 304 inputs the challenge value chal read from the storage unit 308 into the PUF 306. The PUF 306 generates the response value resp to the challenge value chal input from the response generation unit 304. Then, the response value resp generated by the PUF 306 is input into the response generation unit 304. In this manner, the response value resp acquired by the response generation unit 304 by using the PUF 306 is input into the decryption unit 314.

When the response value resp is input from the response generation unit 304, the decryption unit 314 reads the cipher text C=Eᵣₑₛₚ(mk) from the storage unit 308. Then, the decryption unit 314 decrypts the cipher text C by using the response value resp input from the response generation unit 304 as a key. The system secret information mk restored by the decryption processing is input into the shared key generation unit 316. When the system secret information mk is input from the decryption unit 314, the shared key generation unit 316 generates the shared key K by combining the session key Kₛₑₛ input from the mutual authentication unit 312 and the system secret information mk input from the decryption unit 314.

The shared key K generated by the shared key generation unit 316 is input into the key matching verification unit 332. The key matching verification unit 332 checks whether the shared key K input from the shared key generation unit 316 and the shared key K held by the IC card 230 match by a predetermined method. As the predetermined method, various methods including a method using MAC operations of random numbers and a method using digital signatures can be considered. If the key matching verification unit 332 verifies matching of the shared keys K, the shared key K is input into the encryption communication unit 318 from the key matching verification unit 332. If, on the other hand, key matching verification fails, the key matching verification unit 332 terminates authentication processing by outputting an error message.

Then, the encryption communication unit 318 performs encryption communication with the IC card 230 by using the shared key K input from the key matching verification unit 332. If the correct system secret information mk is not restored by the decryption unit 314, it is difficult for the encryption communication unit 318 to perform encryption communication because key matching verification fails in the key matching verification unit 332. Therefore, if the IC card 230 is an illegally duplicated IC or the IC card user terminal 330 is an illegally duplicated IC, even if mutual authentication with the IC card 230 is established, encryption communication to actually read/write information of the IC card user terminals 330 becomes unrealizable.

If it is known that the IC card user terminal 330 is a legal IC, it becomes possible to identify the IC card 230 that failed in key matching verification so that the IC card 230 that may be an illegally duplicated IC can easily be found. Conversely, if it is known that the IC card 230 is a legal IC, it becomes possible to identify the IC card user terminal 330 that failed in key matching verification so that the IC card user terminal 330 that may be an illegally duplicated IC can easily be found.

[3-3: Processing in Authentication Phase]

Next, the flow of processing performed in the authentication phase will be described with reference to FIGS. 18 to 21. In the description thereof, processing between the IC card user terminal 330 and the IC card 230 in the authentication phase is assumed. The IC card user terminal 330 may be denoted as an IC_{I} and the IC card 230 as an IC_{R}. FIG. 18 is an explanatory view showing the overall flow of processing including exchanges between the IC card user terminal 330 and the IC card 230 in the authentication phase.

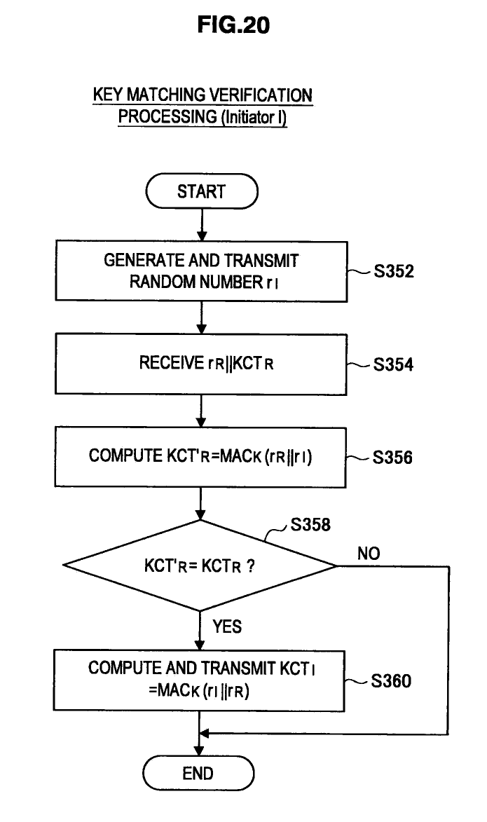

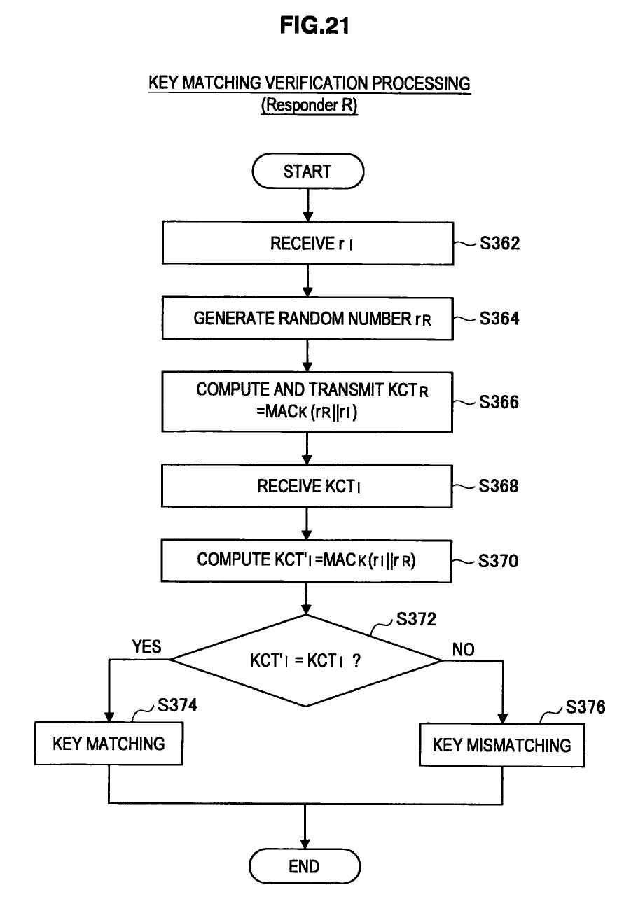

FIG. 19 is an explanatory view showing the overall flow of processing including exchanges between the IC card user terminal 330 and the IC card 230 in the key matching verification phase. FIG. 20 is an explanatory view showing the flow of key matching verification processing performed in the IC card user terminal 330. FIG. 21 is an explanatory view showing the flow of key matching verification processing performed in the IC card 230.

(3-3-1: Overall Flow of Processing)

First, FIG. 18 will be referenced. First, as shown in FIG. 18, mutual authentication processing between the IC card user terminal 330 and the IC card 230 is performed (S302). At this point, if mutual authentication is established, the session key Kₛₑₛ used when a session is established is shared by the IC card user terminal 330 and the IC card 230. The authentication performed at this step is established even if one or both of the IC card user terminal 330 and the IC card 230 are illegally duplicated. Thus, the processing below is performed in the IC card user terminal 330 and the IC card 230.

First, when mutual authentication (S302) is established, the IC card user terminal 330 inputs the challenge value chal into the PUF to acquire a response value resp_{I} (S304). Then, the IC card user terminal 330 decrypts the cipher text C_{I} using the acquired response value resp_{I} to restore the system secret information mk (S306). Note that if the acquired response value resp_{I} is not correct, the correct system secret information mk is not restored. After the system secret information mk being restored, the IC card user terminal 330 computes the shared key K=H(Kₛₑₛ∥mk) used for encryption communication (S308).

Similarly, when mutual authentication (S302) is established, the IC card 230 inputs the challenge value chal into the PUF to acquire the response value resp_{R} (S310). Then, the IC card 230 decrypts the cipher text C_{R} using the acquired response value resp_{R} to restore the system secret information mk (S312). Note that if the acquired response value resp_{R} is not correct, the correct system secret information mk is not restored. After the system secret information mk being restored, the IC card 230 computes the shared key K=H(Kₛₑₛ∥mk) used for encryption communication (S314).

When the shared key K is shared in this manner, key matching verification processing of the shared key K is performed between the IC card user terminal 330 and the IC card 230 (S316; key matching verification phase). If key matching verification is established at step S316, encryption communication using the shared key K is performed between the IC card user terminal 330 and the IC card 230 (S318). In the foregoing, the overall flow of processing concerning a system in the authentication phase has been described. Next, the flow of processing in the key matching verification phase will be described.

(3-3-2: Key Matching Verification Phase)

Next, FIG. 19 will be referenced. Note that the key matching verification method shown in FIGS. 19 to 21 is only an example and the present embodiment is not limited to this method. In this example, the IC card user terminal 330 is assumed to be an initiator that starts key matching verification processing and the IC card 230 a responder corresponding to processing of the initiator. Thus, if key matching confirmation processing is started by the IC card 230, the IC card user terminal 330 becomes the responder.

As shown in FIG. 19, first a random number r_{I} is generated by the IC card user terminal 330 (S322) and a random number r_{R} is generated by the IC card 230 (S324) in the key matching verification phase. Next, the random number r_{I} is sent from the IC card user terminal 330 to the IC card 230 (S326). After receiving the random number r_{I}, the IC card 230 performs a MAC operation to compute KCT_{R}=MAC_{K}(r_{R}∥r_{I}) (S328). MAC_{A}(B) denotes a MAC operation of data B by a key A. Next, the IC card 230 links the random number r_{R} generated at step S324 and KCT_{R} computed at step S328 and sends the linked information to the IC card user terminal 330 (S330).

Next, the IC card user terminal 330 executes a MAC operation using the random number r_{R} received from the IC card 230 to compute KCT_{R}′=MAC_{K}(r_{R}∥r_{I}) (S332). Next, the IC card user terminal 330 determines whether KCT_{R} acquired from the IC card 230 and KCT_{R}′ computed at step S332 match and, if KCT_{R} and KCT_{R}′ do not match, the IC card user terminal 330 terminates a sequence of processing by considering key matching verification as not established (S334). If, on the other hand, KCT_{R} and KCT_{R}′ match, the IC card user terminal 330 executes a MAC operation using the random numbers r_{R} and r_{I} to compute KCT_{I}=MAC_{K}(r_{I}∥r_{R}) (S336).

Then, the IC card user terminal 330 sends KCT_{I} computed at step S336 to the IC card 230 (S338). After receiving KCT_{I}, the IC card 230 executes a MAC operation using the random numbers r_{I} and r_{R} to compute KCT_{I}′=MAC_{K}(r_{I}∥r_{R}) (S340). Then, the IC card 230 determines whether KCT_{I}′ computed at step S340 and KCT_{I} received from the IC card user terminal 330 match and, if KCT_{I} and KCT_{I}′ do not match, the IC card 230 terminates a sequence of processing by considering key matching verification as not established (S342). If, on the other hand, KCT_{I} and KCT_{I}′ match, the IC card 230 starts encryption communication using the shared key K with the IC card user terminal 330.

In the foregoing, the overall flow of processing concerning the key matching verification phase has been described. The flow of processing performed individually by the IC card user terminal 330 and the IC card 230 will be described below in more detail.

First, FIG. 20 will be referenced. As shown in FIG. 20, the IC card user terminal 330 (initiator) generates the random number r_{I} and sends the random number r_{I} to the IC card 230 (responder) (S352). Next, the IC card user terminal 330 receives r_{R}∥KCT_{R} from the IC card 230 (S354). Next, the IC card user terminal 330 executes a MAC operation using the received r_{R} to compute KCT_{R}′=MAC_{K}(r_{R}∥r_{I}) (S356). Next, the IC card user terminal 330 determines whether KCT_{R}′=KCT_{R} (S358). If KCT_{R}′=KCT_{R}, the IC card user terminal 330 computes KCT_{I}=MAC_{K}(r_{I}∥r_{R}) and sends KCT_{I} to the IC card 230 (S360). On the other hand, if KCT_{R}′≠KCT_{R}, the IC card user terminal 330 terminates a sequence of processing by considering keys as a mismatch.

Next, FIG. 21 will be referenced. As shown in FIG. 21, the IC card 230 (responder) receives the random number r_{I} from the IC card user terminal 330 (initiator) (S362). Next, the IC card 230 generates the random number r_{R} and sends the random number r_{R} to the IC card user terminal 330 (S364). Next, the IC card 230 computes KCT_{R}=MAC_{K}(r_{R}∥r_{I}) and sends KCT_{R} to the IC card user terminal 330 (S366). Next, the IC card 230 receives KCT_{I} (S368). Next, the IC card 230 computes KCT_{I}′=MAC_{K}(r_{I}∥r_{R}) (S370). Next, the IC card 230 determines whether KCT_{I}′=KCT_{I} (S372). If KCT_{I}′=KCT_{I}, the IC card 230 determines that keys match (S374) and performs encryption communication using the shared key K. On the other hand, if KCT_{I}′≠KCT_{I}, the IC card 230 terminates a sequence of processing by considering keys as a mismatch (S376).

In the foregoing, processing of the key matching phase according to the present embodiment has been described. While key matching is verified by using a MAC operation of random numbers using the shared key K in the above key matching verification processing, a method of using digital signatures by a key for mutual authentication can also be considered when a technology according to the present embodiment is realized by using, for example, public key encryption technology. Regarding the random numbers r_{I} and r_{R}, a wide range of variations such as using random numbers or cipher text used for performing mutual authentication processing can be considered. It is needless to say that such variations are also included in the technical scope of the present embodiment.

In the foregoing, the second embodiment of the present invention has been described. After mutual authentication, as described above, risks of illegal cipher text being decrypted can be avoided by performing key matching verification. Moreover, the presence of an illegally duplicated IC can be identified in a situation in which though a key for mutual authentication is acquired together with each piece of data through illegal duplication, which data of acquired data is the key for mutual authentication is not exposed. That is, an IC that causes a mismatch in the key matching verification phase, though mutual authentication is established, is an illegally duplicated IC and the illegally duplicated IC can be found by applying technology of the present embodiment.

### 4: Third Embodiment

Next, the third embodiment of the present invention will be described. In the above first and second embodiments, whether an IC is an illegally duplicated IC is determined by verifying whether encryption communication can be performed correctly after mutual authentication being established or whether shared keys match. Then, according to the method in the first embodiment, it is necessary to decrypt cipher text to verify whether the communication partner is valid. According to the method in the second embodiment, though validity can be verified before cipher text being decrypted, the amount of communication is larger than the method in the first embodiment by an amount necessary to perform key matching verification processing. Thus, the inventors of the present invention studied a method to verify validity before cipher text being decrypted without increasing the amount of communication. What is invented as a result thereof is the method in the third embodiment described below.

According to the method in the third embodiment, instead of system secret information, a mutual authentication key is encrypted by a response value in the registration phase, the mutual authentication key is decrypted by the response value in the authentication phase, and mutual authentication is performed by the decrypted mutual authentication key. The method in the third embodiment is the same as the above first and second embodiments in that features that it is very difficult for an illegally duplicated IC to obtain a correct response value, but is significantly different in that mutual authentication by an illegally duplicated IC is prevented. If mutual authentication is not established, a correct session key is not obtained, which makes it difficult to perform encryption communication using the session key. Therefore, falsification or theft of information by an illegally duplicated IC can efficiently be prevented. Moreover, since it is difficult for an illegally duplicated IC to perform mutual authentication, the communication partner is spared decryption of illegal cipher text and also key matching verification processing does not occur.

[4-1: Functional Configuration of IC Card 250]

First, the functional configuration of the IC card 250 according to the third embodiment of the present invention will be described with reference to FIG. 22. Therein, the main functional configuration of a center 150 according to the present embodiment will also be described. The same reference numerals are attached to components having substantially the same functions as those of the IC card 200 according to the first embodiment described above to omit a detailed description thereof. FIG. 22 is an explanatory view showing the functional configuration of the IC card 250 according to the present embodiment.

As shown in FIG. 22, the IC card 250 mainly includes the key information acquisition unit 202, the response generation unit 204, the PUF 206, the storage unit 208, an encryption unit 252, a decryption unit 254, a mutual authentication unit 256, and an encryption communication unit 258. The center 150 mainly includes a key information providing unit 152 and a storage unit 154.

The functional configuration of the IC card 250 will be described below separately for each phase. In the registration phase according to the present embodiment, a challenge value (chal) common to each IC is provided. Then, a response value resp to the challenge value chal is generated by each IC and the mutual authentication key Kₐᵤₜₕ is encrypted by using the response value resp as a key. Cipher text EK=Eᵣₑₛₚ(Kₐᵤₜₕ) generated by the encryption processing is stored in a nonvolatile memory in each IC together with the challenge value chal.

In the authentication phase according to the present embodiment, on the other hand, each IC reads the cipher text EK and the challenge value chal stored in the nonvolatile memory by each IC and inputs the challenge value chal into the PUF 206 to generate the response value resp. Then, each IC decrypts the cipher text EK using the generated resp and performs mutual authentication using the mutual authentication key Kₐᵤₜₕ obtained by decrypting the cipher text EK. As a result, it is difficult for an illegally duplicated IC to obtain the mutual authentication key Kₐᵤₜₕ, making it difficult to cause mutual authentication to be established. In the present embodiment, by using the method described above, mutual authentication is made realizable while an illegally duplicated IC is prevented from being used.

(Functional Configuration Concerning the Registration Phase)

First, the functional configuration of the IC card 250 concerning the registration phase will be described. In the registration phase, the challenge value chal and the mutual authentication key Kₐᵤₜₕ that are common throughout the system are first provided from the center 150 to the IC card 250. The challenge value chal and the mutual authentication key Kₐᵤₜₕ are stored in the storage unit 154 held by the center 150. Then, in the registration phase, the challenge value chal and the mutual authentication key Kₐᵤₜₕ are read by the key information providing unit 152 held by the center 150 from the storage unit 154 and provided to each of the IC cards 250. The challenge value chal and the mutual authentication key Kₐᵤₜₕ provided from the center 150 are acquired by the key information acquisition unit 202 held by the IC card 250.

Then, the challenge value chal acquired by the key information acquisition unit 202 is stored in the storage unit 208. The mutual authentication key Kₐᵤₜₕ acquired by the key information acquisition unit 202 is input into the encryption unit 252. The challenge value chal stored in the storage unit 208 is read by the response generation unit 204 and input into the PUF 206. The PUF 206 generates the response value resp to the challenge value chal input from the response generation unit 204. The response value resp output from the PUF 206 is specific to the IC card 250. The response value resp generated by the PUF 206 is input into the response generation unit 204. After the response value resp being generated in this manner, the response generation unit 204 inputs the response value resp into the encryption unit 252.

As described above, the mutual authentication key Kₐᵤₜₕ from the key information acquisition unit 202 is input into the encryption unit 252 and also the response value resp from the response generation unit 204 is into the encryption unit 252. Then, the encryption unit 252 encrypts the mutual authentication key Kₐᵤₜₕ by using the input response value resp as a key. The cipher text EK=Eᵣₑₛₚ(Kₐᵤₜₕ) is generated by the encryption processing. The cipher text EK generated by the encryption unit 252 is stored in the storage unit 208. Processing up to this point is performed in the registration phase. After the above processing, the storage unit 208 of the IC card 250 has the challenge value chal and the cipher text EK stored therein. Note that the mutual authentication key Kₐᵤₜₕ is not stored inside the IC card 250.

(Functional Configuration Concerning the Authentication Phase)

Next, the functional configuration of the IC card 250 concerning the authentication phase will be described. In the authentication phase, mutual authentication is first performed between the IC card 250 and the IC card user terminal 350. The mutual authentication key Kₐᵤₜₕ used for mutual authentication is not stored in the storage unit 208. Thus, in the authentication phase, generation processing of the mutual authentication key Kₐᵤₜₕ used to realize mutual authentication with the IC card user terminal 350 is performed.

First, the challenge value chal is read by the response generation unit 204 from the storage unit 208. Then, the response generation unit 204 inputs the challenge value chal read from the storage unit 208 into the PUF 206. The PUF 206 generates the response value resp to the challenge value chal input from the response generation unit 204. Then, the response value resp generated by the PUF 206 is input into the response generation unit 204. In this manner, the response value resp acquired by the response generation unit 204 by using the PUF 206 is input into the decryption unit 254.

While a description is given here that the response value resp is generated by the PUF 206, if the IC card 250 is an illegally duplicated IC, a response value resp′ (≠resp) is generated by the PUF 206. The IC card 250 that generated the response value resp in the registration phase is an original IC assumed by the center 150. In the IC card 250 generated by illegal duplication of the IC card 250, on the other hand, the same configuration including the cipher text EK and the challenge value chal stored in the storage unit 208 is reproduced. However, the original IC and the illegally duplicated IC do differ in input/output characteristics of the PUF 206. Thus, an IC can be distinguished between an original IC and an illegally duplicated IC each time authentication is performed by the PUF 206 being caused to generate the response value resp again by the response generation unit 204.

When the response value resp is input from the response generation unit 204, the decryption unit 254 reads the cipher text EK=Eᵣₑₛₚ(Kₐᵤₜₕ) from the storage unit 208. Then, the decryption unit 254 decrypts the cipher text EK by using the response value resp input from the response generation unit 204 as a key. The mutual authentication key Kₐᵤₜₕ restored by the decryption processing is input into the mutual authentication unit 256. If the response value input from the response generation unit 204 is different from that used when the cipher text EK was generated, the correct mutual authentication key Kₐᵤₜₕ is not restored. That is, an original IC and an illegally duplicated IC can be distinguished based on whether or not the mutual authentication key Kₐᵤₜₕ restored by the decryption unit 254 is correct.

After the mutual authentication key Kₐᵤₜₕ being input, the mutual authentication unit 256 performs mutual authentication with the IC card user terminal 350 using the input mutual authentication key Kₐᵤₜₕ. Then, after mutual authentication being established, the mutual authentication unit 256 acquires the session key Kₛₑₛ used to establish a session with the IC card user terminal 350. The session key Kₛₑₛ acquired by the mutual authentication unit 256 is input into the encryption communication unit 258. Then, the encryption communication unit 258 performs encryption communication with the IC card user terminal 350 using the session key Kₛₑₛ input from the mutual authentication unit 256.

If the correct mutual authentication key Kₐᵤₜₕ is not restored by the decryption unit 254, mutual authentication by the mutual authentication unit 256 is not established and thus, the session key Kₛₑₛ is not input into the encryption communication unit 258. Thus, encryption communication by an illegally duplicated IC is not realizable. Therefore, if the IC card 250 is an illegally duplicated IC, encryption communication to actually read/write information of the IC card 250 becomes unrealizable.

[4-2: Functional Configuration of IC Card User Terminal 350]

Next, the functional configuration of the IC card user terminal 350 according to the third embodiment of the present invention will be described with reference to FIG. 23. Therein, the main functional configuration of the center 150 according to the present embodiment will also be described. FIG. 23 is an explanatory view showing the functional configuration of the IC card user terminal 350 according to the present embodiment. The same reference numerals are attached to components having substantially the same functions as those of the IC card 200 according to the first embodiment described above to omit a detailed description thereof. Mutual authentication between the IC card 250 and the IC card user terminal 350 is also assumed in the present embodiment and thus, the substantially the same functional configuration is provided in the IC card user terminal 350 as in the IC card 250.

As shown in FIG. 23, the IC card user terminal 350 mainly includes the key information acquisition unit 302, the response generation unit 304, the PUF 306, the storage unit 308, an encryption unit 352, a decryption unit 354, a mutual authentication unit 356, and an encryption communication unit 358.

The functional configuration of the IC card user terminal 350 will be described below separately for each phase. In the registration phase according to the present embodiment, the challenge value (chal) common to each IC is provided. Then, the response value resp to the challenge value chal is generated by each IC and the mutual authentication key Kₐᵤₜₕ is encrypted by using the response value resp as a key. The cipher text EK=Eᵣₑₛₚ(Kₐᵤₜₕ) generated by the encryption processing is stored in a nonvolatile memory in each IC together with the challenge value chal.

In the authentication phase according to the present embodiment, on the other hand, each IC reads the cipher text EK and the challenge value chal stored in the nonvolatile memory by each IC and inputs the challenge value chal into the PUF 306 to generate the response value resp. Then, each IC decrypts the cipher text EK using the generated resp and performs mutual authentication using the mutual authentication key Kₐᵤₜₕ obtained by decrypting the cipher text EK. As a result, it is difficult for an illegally duplicated IC to obtain the correct mutual authentication key Kₐᵤₜₕ, making it difficult to cause mutual authentication to be established. In the present embodiment, by using the method described above, mutual authentication is made realizable while an illegally duplicated IC is prevented from being used.

(Functional Configuration Concerning the Registration Phase)

First, the functional configuration of the IC card user terminal 350 concerning the registration phase will be described. In the registration phase, the challenge value chal and the mutual authentication key Kₐᵤₜₕ that are common throughout the system are first provided from the center 150 to the IC card user terminal 350. The challenge value chal and the mutual authentication key Kₐᵤₜₕ provided from the center 150 are acquired by the key information acquisition unit 302 held by the IC card user terminal 350. Then, the challenge value chal acquired by the key information acquisition unit 302 is stored in the storage unit 308.

The mutual authentication key Kₐᵤₜₕ acquired by the key information acquisition unit 302 is input into the encryption unit 352. The challenge value chal stored in the storage unit 308 is read by the response generation unit 304 and input into the PUF 306. The PUF 306 generates the response value resp to the challenge value chal input from the response generation unit 304. The response value resp output from the PUF 306 is specific to the IC card user terminals 350. The response value resp generated by the PUF 306 is input into the response generation unit 304. After the response value resp being generated in this manner, the response generation unit 304 inputs the response value resp into the encryption unit 352.

As described above, the mutual authentication key Kₐᵤₜₕ from the key information acquisition unit 302 is input into the encryption unit 352 and also the response value resp from the response generation unit 304 is into the encryption unit 352. Then, the encryption unit 352 encrypts the mutual authentication key Kₐᵤₜₕ by using the input response value resp as a key. The cipher text EK=Eᵣₑₛₚ(Kₐᵤₜₕ) is generated by the encryption processing. The cipher text EK generated by the encryption unit 352 is stored in the storage unit 308. Processing up to this point is performed in the registration phase. After the above processing, the storage unit 308 of the IC card user terminal 350 has the challenge value chal and the cipher text EK stored therein. Note that the mutual authentication key Kₐᵤₜₕ is not stored inside the IC card user terminal 350.

(Functional Configuration Concerning the Authentication Phase)

Next, the functional configuration of the IC card user terminal 350 concerning the authentication phase will be described. In the authentication phase, mutual authentication is first performed between the IC card user terminal 350 and the IC card 250. The mutual authentication key Kₐᵤₜₕ used for mutual authentication is not stored in the storage unit 308. Thus, in the authentication phase, generation processing of the mutual authentication key Kₐᵤₜₕ used to realize mutual authentication with the IC 250 is performed.

First, the challenge value chal is read by the response generation unit 304 from the storage unit 308. Then, the response generation unit 304 inputs the challenge value chal read from the storage unit 308 into the PUF 306. The PUF 306 generates the response value resp to the challenge value chal input from the response generation unit 304. Then, the response value resp generated by the PUF 306 is input into the response generation unit 304. In this manner, the response value resp acquired by the response generation unit 304 by using the PUF 306 is input into the decryption unit 354.

When the response value resp is input from the response generation unit 304, the decryption unit 354 reads the cipher text EK=Eᵣₑₛₚ(Kₐᵤₜₕ) from the storage unit 308. Then, the decryption unit 354 decrypts the cipher text EK by using the response value resp input from the response generation unit 304 as a key. The mutual authentication key Kₐᵤₜₕ restored by the decryption processing is input into the mutual authentication unit 356. If the response value input from the response generation unit 304 is different from that used when the cipher text EK was generated, the correct mutual authentication key Kₐᵤₜₕ is not restored. That is, an original IC and an illegally duplicated IC can be distinguished based on whether or not the mutual authentication key Kₐᵤₜₕ restored by the decryption unit 354 is correct.

After the mutual authentication key Kₐᵤₜₕ being input, the mutual authentication unit 356 performs mutual authentication with the IC card 250 using the input mutual authentication key Kₐᵤₜₕ. Then, after mutual authentication being established, the mutual authentication unit 356 acquires the session key Kₛₑₛ used to establish a session with the IC card 250. The session key Kₛₑₛ acquired by the mutual authentication unit 356 is input into the encryption communication unit 358. The encryption communication unit 358 performs encryption communication with the IC card 250 using the session key Kₛₑₛ input from the mutual authentication unit 356.

If the correct mutual authentication key Kₐᵤₜₕ is not restored by the decryption unit 354, mutual authentication by the mutual authentication unit 356 is not established and thus, the session key Kₛₑₛ is not input into the encryption communication unit 358. Thus, encryption communication by an illegally duplicated IC is not realizable. Therefore, if the IC card user terminal 350 is an illegally duplicated IC, encryption communication to actually read/write information of the IC card 250 becomes unrealizable.

[4-3: Processing in Authentication Phase]

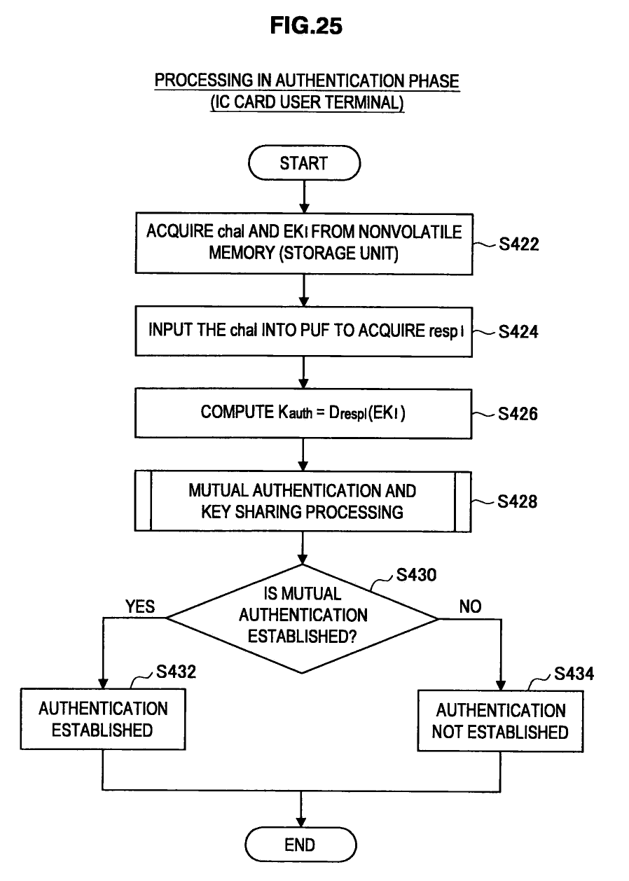

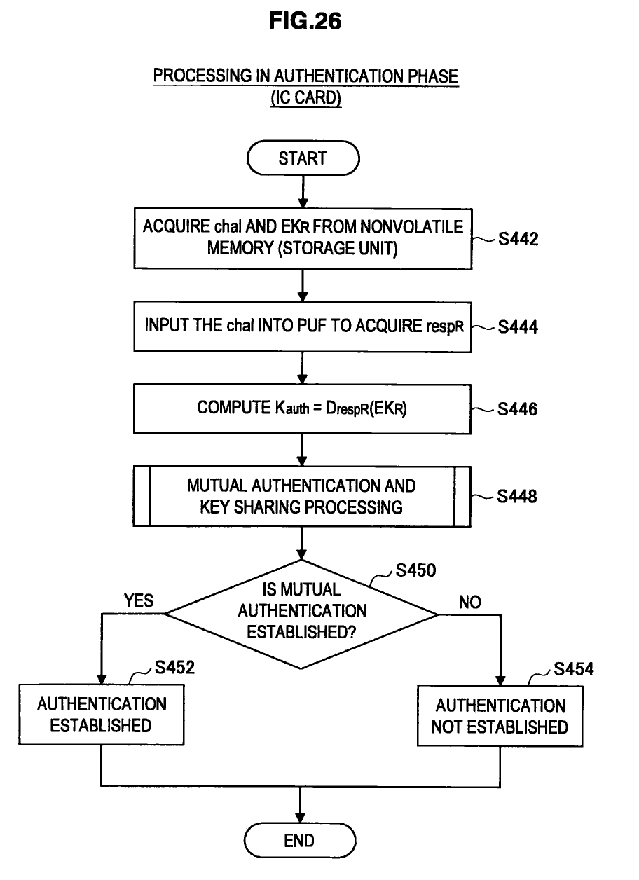

Next, the flow of processing performed in the authentication phase will be described with reference to FIGS. 24 to 26. FIG. 24 is an explanatory view showing the overall flow of processing including exchanges between the IC card user terminal 350 and the IC card 250 in the authentication phase. FIG. 25 is an explanatory view showing the flow of processing performed mainly in the IC card user terminal 350. FIG. 26 is an explanatory view showing the flow of processing performed mainly in the IC card 250.

First, FIG. 24 will be referenced. As shown in FIG. 24, the IC card user terminal 350 first inputs the challenge value chal into the PUF to acquire a response value resp_{I} (S402). Then, the IC card user terminal 350 decrypts cipher text EK_{I} using the acquired response value resp_{I} to restore the mutual authentication key Kₐᵤₜₕ (S404). Note that if the acquired response value resp_{I} is not correct, the correct mutual authentication key Kₐᵤₜₕ is not restored.

Similarly, the IC card 250 inputs the challenge value chal into the PUF to acquire a response value resp_{R} (S406). Then, the IC card 250 decrypts cipher text EK_{R} using the acquired response value resp_{R} to restore the mutual authentication key Kₐᵤₜₕ (S408). Note that if the acquired response value resp_{R} is not correct, the correct mutual authentication key Kₐᵤₜₕ is not restored.

Then, each of the IC card user terminal 350 and the IC card 250 performs mutual authentication using the decrypted mutual authentication key Kₐᵤₜₕ and, if mutual authentication is established, the IC card user terminal 350 and the IC card 250 share the session key Kₛₑₛ (S410). If the session key Kₛₑₛ is shared, encryption communication is performed between the IC card user terminal 350 and the IC card 250 (S412). In the foregoing, the overall flow of processing concerning the authentication phase has been described. The flow of processing performed individually by the IC card user terminal 350 and the IC card 250 will be described below in more detail.

First, FIG. 25 will be referenced. As shown in FIG. 25, the IC card user terminal 350 acquires the challenge value chal and the cipher text EK_{I} from the storage unit 308 (S422). Next, the IC card user terminal 350 inputs the challenge value chal into the PUF 306 to acquire the response value resp_{I} (S424). Next, the IC card user terminal 350 decrypts the cipher text EK_{I} using the acquired response value resp_{I} to acquire the mutual authentication key Kₐᵤₜₕ (S426). Next, the IC card user terminal 350 performs mutual authentication and key sharing processing using the acquired mutual authentication key Kₐᵤₜₕ (S428).

Next, the IC card user terminal 350 determines whether mutual authentication has been established (S430). If mutual authentication has been established, the IC card user terminal 350 performs encryption communication using the session key Kₛₑₛ acquired at step S428 by considering authentication as established (S432). If, on the other hand, mutual authentication has not been established, the IC card user terminal 350 terminates a sequence of processing concerning authentication processing by considering authentication as not established (S434).

If the IC card user terminal 350 should be an illegally duplicated IC, the response value resp_{I} acquired at step S424 is different from the legal one and thus, the correct mutual authentication key Kₐᵤₜₕ is not restored at step S426. Therefore, the mutual authentication fails at step S428. As a result, it is very difficult to illegally read/write information in the IC card 250 or to illegally read/write information in the IC card user terminal 350 by illegal duplication attacks.

Next, FIG. 26 will be referenced. As shown in FIG. 26, the IC card 250 acquires the challenge value chal and the cipher text EK_{R} from the storage unit 208 (S442). Next, the IC card 250 inputs the challenge value chal into the PUF 206 to acquire the response value resp_{I} (S444). Next, the IC card 250 decrypts the cipher text EK_{R} using the acquired response value resp_{R} to acquire the mutual authentication key Kₐᵤₜₕ (S446). Next, the IC card 250 performs mutual authentication and key sharing processing using the acquired mutual authentication key Kₐᵤₜₕ (S448).

Next, the IC card 250 determines whether mutual authentication has been established (S450). If mutual authentication has been established, the IC card 250 performs encryption communication using the session key Kₛₑₛ acquired at step S448 by considering authentication as established (S452). If, on the other hand, mutual authentication has not been established, the IC card 250 terminates a sequence of processing concerning authentication processing by considering authentication as not established (S454).

If the IC card 250 should be an illegally duplicated IC, the response value resp_{R} acquired at step S444 is different from the legal one and thus, the correct mutual authentication key Kₐᵤₜₕ is not restored at step S446. Therefore, the mutual authentication fails at step S448. As a result, it is very difficult to illegally read/write information in the IC card user terminal 350 or to illegally read/write information in the IC card 250 by illegal duplication attacks.

In the foregoing, the third embodiment of the present invention has been described. By using, as described above, the authentication processing method according to the present embodiment, like the above first and second embodiments, tampering by an illegally duplicated IC can be prevented by making the most of PUF characteristics. Moreover, unlike the above first embodiment, validity of the communication partner can be determined without increasing the amount of communication and without decrypting cipher text of the communication partner received through encryption communication.

### 5: Summary

Lastly, the above authentication processing method according to each embodiment will briefly be summarized. The authentication processing method according to each embodiment relates to technology to prevent an illegally duplicated IC from being used by mounting a PUF in a semiconductor integrated circuit (IC) and using characteristics of the PUF for mutual authentication. The authentication processing method realizes prevention of an illegally duplicated IC from being used by checking whether system secret information or a mutual authentication key encrypted by using a PUF output value as a key can be decrypted without using a database like in the SD07 method.

Here, differences between the SD07 method and the above method of each embodiment will briefly be summarized. According to the SD07 method, as described above, the center generates a database in which pairs of challenges/responses corresponding to the PUF of each IC are stored in the registration phase and manages the database in secret. In the authentication phase, a terminal references the database of the center to determine whether an IC outputs the same response value as that registered in the database by giving the registered challenge value to the IC. Further, according to the SD07 method, an illegally duplicated IC is prevented from being used by deciding whether authentication is successful by receiving a result of the determination.

However, if such a configuration method is adopted, the center constructs a very huge database and it becomes necessary to securely hold and manage the database. Further, it is necessary to store the database in an IC to perform mutual authentication, which makes mutual authentication substantially unrealizable. If, for example, the total number N of manufactured ICs is N=10,000,000 and data sizes of the ID, challenge value, and response value of each IC are each 128 bits and 100 challenges/responses are registered for each IC, the database size will be about 320 GB. It is very difficult to store data of such a huge size in a nonvolatile memory of an IC.

According to the method of each embodiment of the present invention, on the other hand, only one ID, one challenge value, and one piece of system secret information or one mutual authentication key are given to each IC in the registration phase. Moreover, the challenge value and system secret information can be made common throughout the system. Thus, there is no need for a terminal or IC to access the center to verify the output value of PUF in the authentication phase. Therefore, there is no need for the center to hold information to realize mutual authentication.

Consequently, mutual authentication between a terminal and IC can be realized. Since each IC or terminal decrypts cipher text by using the output value of PUF in the authentication phase, whether or not each IC or terminal is illegally duplicated can be determined based on whether the decryption value is correct when mutual authentication is performed. As a result, like the SD07 method, an illegally duplicated IC can be prevented from being used. Further if the above method in the second embodiment is used, there is no need to decrypt cipher text received from the communication partner to verify whether there is any illegal IC so that security can further be enhanced. If the above method in the third embodiment is used, whether the communication partner is illegally duplicated can be verified without increasing the amount of communication and without decrypting cipher text received from the communication partner.

(Notes)

The IC cards 200, 230, and 250 and the IC card user terminals 300, 330, and 350 described above are examples of an integrated circuit or encryption communication apparatus. The PUFs 206 and 306 described above are examples of an arithmetic circuit. The system secret information mk in the first and second embodiments and the mutual authentication key Kₐᵤₜₕ in the third embodiment described above are examples of predetermined secret information. The challenge value described above is an example of a predetermined value input into an arithmetic circuit. The response generation units 204 and 304 described above are examples of an output value acquisition unit. The shared key generation units 216 and 316 described above are examples of an encryption communication key generation unit. The shared key K described above is an example of a key for encryption communication. Further, the session key Kₛₑₛ described above is an example of shared information acquired through mutual authentication. The IC card 230 and the IC card user terminal 330 described above are examples of a first or second communication apparatus. The key matching verification units 232 and 332 described above are examples of an arithmetic unit and transmission unit.

It should be understood by those skilled in the art that various modifications, combinations, sub-combinations and alterations may occur depending on design requirements and other factors insofar as they are within the scope of the appended claims or the equivalents thereof.

The present application contains subject matter related to that disclosed in Japanese Priority Patent Application JP 2009-073676 filed in the Japan Patent Office on Mar. 25, 2009, the entire content of which is hereby incorporated by reference.

What is claimed is:

1. An integrated circuit, comprising:
an arithmetic circuit having input/output characteristics determined by element-specific physical characteristics;
a storage unit having cipher text obtained by performing encryption processing on predetermined secret information using an output value output from the arithmetic circuit with respect to input of a predetermined value and the predetermined value input into the arithmetic circuit stored therein; and
a decryption unit that restores the predetermined secret information by inputting the predetermined value stored in the storage unit into the arithmetic circuit and decrypting the cipher text stored in the storage unit using the output value output from the arithmetic circuit when the predetermined secret information is used.

2. The integrated circuit according to claim 1, further comprising:
an output value acquisition unit that inputs the predetermined value into the arithmetic circuit to acquire the output value and also stores the predetermined value in the storage unit when the predetermined value is given from outside; and
an encryption unit that encrypts the predetermined secret information using the output value acquired by the output value acquisition unit by using the arithmetic circuit as a key and stores the cipher text obtained by the encryption processing to the storage unit when the predetermined secret information is given together with the predetermined value.

3. The integrated circuit according to claim 1, wherein a key for mutual authentication is stored in the storage unit as the predetermined secret information in a form of the cipher text using the output value as the key and
when mutual authentication is performed using the key for mutual authentication, the decryption unit restores the key for mutual authentication by inputting the predetermined value stored in the storage unit into the arithmetic circuit and decrypting the cipher text stored in the storage unit using the output value output from the arithmetic circuit.

4. An encryption communication apparatus, comprising:
an integrated circuit including an arithmetic circuit having input/output characteristics determined by element-specific physical characteristics, a storage unit having cipher text obtained by performing encryption processing on predetermined secret information shared with an external apparatus using an output value output from the arithmetic circuit with respect to input of a predetermined value and the predetermined value input into the arithmetic circuit stored therein, and a decryption unit that restores the predetermined secret information by inputting the predetermined value stored in the storage unit into the arithmetic circuit and decrypting the cipher text stored in the storage unit using the output value output from the arithmetic circuit when the predetermined secret information is used;
a mutual authentication unit that acquires shared information by performing mutual authentication with the external apparatus;
an encryption communication key generation unit that generates a key for encryption communication by combining the shared information acquired through the mutual authentication by the mutual authentication unit and the predetermined secret information restored by the decryption unit; and
an encryption communication unit that performs encryption communication with the external apparatus using the key for encryption communication generated by the encryption communication key generation unit.

5. An encryption communication system, including:
a first communication apparatus; having:
an integrated circuit including an arithmetic circuit having input/output characteristics determined by element-specific physical characteristics, a storage unit having cipher text obtained by performing encryption processing on predetermined secret information using an output value output from the arithmetic circuit as a key with respect to input of a predetermined value and the predetermined value input into the arithmetic circuit stored therein, and a decryption unit that restores the predetermined secret information by inputting the predetermined value stored in the storage unit into the arithmetic circuit and decrypting the cipher text stored in the storage unit using the output value output from the arithmetic circuit when the predetermined secret information is used;
a mutual authentication unit that acquires shared information by performing mutual authentication with a second communication apparatus;
an encryption communication key generation unit that restores the predetermined secret information by using the decryption unit to generate a key for encryption communication by combining the predetermined secret information and the shared information if the shared information is acquired after the successful mutual authentication with the second communication apparatus; and
an encryption communication unit that performs encryption communication with the second communication apparatus using the key for encryption communication generated by the encryption communication key generation unit; and
the second communication apparatus; having:
an integrated circuit including an arithmetic circuit having input/output characteristics determined by element-specific physical characteristics, a storage unit having the cipher text obtained by performing encryption processing on the predetermined secret information using an output value output from the arithmetic circuit as a key with respect to input of a predetermined value and the predetermined value input into the arithmetic circuit stored therein, and a decryption unit that restores the predetermined secret information by inputting the predetermined value stored in the storage unit into the arithmetic circuit and decrypting the cipher text stored in the storage unit using the output value output from the arithmetic circuit when the predetermined secret information is used;
a mutual authentication unit that acquires the shared information by performing the mutual authentication with the first communication apparatus;
an encryption communication key generation unit that restores the predetermined secret information by using the decryption unit to generate a key for encryption communication by combining the predetermined secret information and the shared information if the shared information is acquired after the successful mutual authentication with the first communication apparatus; and
an encryption communication unit that performs encryption communication with the first communication apparatus using the key for encryption communication generated by the encryption communication key generation unit.

6. The encryption communication system according to claim 5, wherein
the first communication apparatus; further having:
an arithmetic unit that performs predetermined arithmetic processing with the key for encryption communication generated by the encryption communication key generation unit as a parameter on held information held by the first and second communication apparatuses; and
a transmission unit that transmits a first arithmetic result output from the arithmetic unit to the second communication apparatus and
the second communication apparatus; further having:
an arithmetic unit that performs predetermined arithmetic processing with the key for encryption communication generated by the encryption communication key generation unit as a parameter on held information held by the first and second communication apparatuses; and
a transmission unit that transmits a second arithmetic result output from the arithmetic unit to the first communication apparatus, wherein
the first communication apparatus compares the second arithmetic result received from the second communication apparatus and the first arithmetic result,
the second communication apparatus compares the first arithmetic result received from the first communication apparatus and the second arithmetic result, and
the encryption communication units held by the first and second communication apparatus perform the encryption communication if the first and second arithmetic results match.

7. An information processing method; comprising the steps of:
acquiring an output value corresponding to a predetermined value after the predetermined value stored in the storage unit being input into the arithmetic circuit when the predetermined secret information is used by using an integrated circuit including an arithmetic circuit having input/output characteristics determined by element-specific physical characteristics and a storage unit having cipher text obtained by performing encryption processing on predetermined secret information using an output value output from the arithmetic circuit as a key with respect to input of a predetermined value and the predetermined value input into the arithmetic circuit stored therein; and
restoring the predetermined secret information by decrypting the cipher text stored in the storage unit using the output value output from the arithmetic circuit in the output value acquisition step.

8. The information processing method according to claim 7; further comprising the steps of:
acquiring shared information by performing mutual authentication with an external apparatus;
generating a key for encryption communication by combining the shared information acquired by the mutual authentication in the mutual authentication step and the predetermined secret information restored in the restoration step; and
performing encryption communication with the external apparatus using the key for encryption communication generated in the key generation step.

9. An encryption communication method, comprising the steps of:
acquiring shared information by performing mutual authentication with a second communication apparatus;
acquiring an output value corresponding to a predetermined value after the predetermined value stored in the storage unit being input into the arithmetic circuit if the shared information is acquired after the successful mutual authentication with the second communication apparatus by using an integrated circuit including an arithmetic circuit having input/output characteristics determined by element-specific physical characteristics and a storage unit having cipher text obtained by performing encryption processing on predetermined secret information using an output value as a key output from the arithmetic circuit with respect to input of a predetermined value and the predetermined value input into the arithmetic circuit stored therein;
restoring the predetermined secret information by decrypting the cipher text stored in the storage unit using the output value output from the arithmetic circuit in the output value acquisition step;
generating a key for encryption communication by combining the predetermined secret information restored in the restoration step and the shared information; and
performing encryption communication with the second communication apparatus using the key for encryption communication generated in the key generation step
by a first communication apparatus and
acquiring shared information by performing the mutual authentication with the first communication apparatus;
acquiring an output value corresponding to a predetermined value after the predetermined value stored in the storage unit being input into the arithmetic circuit if the shared information is acquired after the successful mutual authentication with the second communication apparatus by using an integrated circuit including an arithmetic circuit having input/output characteristics determined by element-specific physical characteristics and a storage unit having the cipher text obtained by performing encryption processing on predetermined secret information using an output value as a key output from the arithmetic circuit with respect to input of a predetermined value and the predetermined value input into the arithmetic circuit stored therein;
restoring the predetermined secret information by decrypting the cipher text stored in the storage unit using the output value output from the arithmetic circuit in the output value acquisition step;
generating a key for encryption communication by combining the predetermined secret information restored in the restoration step and the shared information; and
performing encryption communication with the first communication apparatus using the key for encryption communication generated in the key generation step
by the second communication apparatus.
